(19) United States
(12) Patent Application Publication
(10) Pub. No.: US 2026/0300263 A1
(43) Pub. Date: Oct. 1, 2026

(54) Table-Based Data Provisioning Between Devices

(71) Applicant: Tabs Data, Inc., Sunnyvale, CA (US)

(72) Inventors: Arvind Prabhakar, Sunnyvale, CA (US); Alejandro Humberto Abdelnur, Asunción (PY); Dimas Cabré i Chacón, Gava (ES); Joaquin Bo Diaz, Barcelona (ES); Aleix Lascorz Guiu, Barcelona (ES)

(21) Appl. No.: 19/530,195

(22) Filed: Feb. 4, 2026

Related U.S. Application Data
(60) Provisional application No. 63/753,816, filed on Feb. 4, 2025.

(51) Int. Cl. G06F 16/23

(52) U.S. Cl. CPC G06F 16/2365; G06F 16/2329; G06F 16/2379

(57) ABSTRACT

A publish-subscribe data provisioning system employs a generator-receiver model for tables where network systems generate data from source systems and client devices receive these tables. Each data structure comprises rows with an identifier column storing a unique identifier for each row and a source column containing identifiers of records from other tables used to create the current record. Functions control how data is translated between tables and client devices, including generator functions mapping data from sources to tables, receiver functions mapping tables to data sources, and transformation functions mapping between tables. Dependency graphs define relationships between tables, enabling execution plans that propagate changes through the system. The architecture supports complete lineage tracking and record-level provenance, enabling bidirectional traceability of data origins and transformations across the system.

### CROSS REFERENCE TO RELATED APPLICATIONS

This application claims priority to U.S. Provisional Application Ser. No. 63/753,816 filed Feb. 4, 2025, which is incorporated by reference in its entirety

### FIELD OF DISCLOSURE

This disclosure relates to data integration and data provisioning systems. More specifically, this disclosure relates to table-based data provisioning systems that employ publish-subscribe architectures with integrated provenance tracking mechanisms for maintaining data lineage across distributed transformations.

### BACKGROUND

Data integration combines data from multiple sources to support operations and analytics, but it has grown increasingly complex with evolving data systems. Existing solutions generally fall into two categories: data virtualization systems, which provide access to data where it resides but struggle with complexity and performance, and data movement systems, which scale well but lack semantic cohesion and domain ownership. Both of these approaches have many drawbacks, some of which are reported below. Therefore, a service that leverages the strengths of both and enables seamless access to data would be useful.

### SUMMARY

In some aspects, the techniques described herein relate to a method for storing provenance information in a data provisioning network system, the method including: receiving, at the data provisioning network system, a request to add a new function to a set of data structures; accessing one or more input data structures from the set of data structures associated with the new function, wherein each of the input data structures includes, for each row in the input data structure, an identifier for the row stored in an identifier column of the input data structure; generating an output data structure based on the new function, the generation including, for each row in the output data structure: assigning a new identifier to the row and storing the new identifier in an identifier column of the output data structure; and populating a new source column of the output data structure with identifiers for rows in the input data structures that modify data elements in the row of the output data structure, wherein identifiers present in the new source column maintain provenance information linking data in rows of the output data structure to rows in the input data structure; and providing, in response to receiving a request for provenance information for an element in the output data structure, provenance information for the element based on the provenance information in the new source column of the output data structure.

In some aspects, the techniques described herein relate to a method, wherein each input data structure of the one or more input data structures includes, for each row in the input data structure, a source column with identifiers for rows in additional input data structures of the set of data structures that modify data elements in the row of the input data structure, the method further including: providing the provenance information for the element in the output data structure is additionally based on the provenance information in the source columns of the one or more input data structures.

In some aspects, the techniques described herein relate to a method, wherein the new function is a projection function configured for selecting a subset of columns from the input data structures for insertion into the output data structure, and the method further includes: populating the new source column includes, for each row in the output data structure, copying identifiers from a source column of a corresponding row in the input data structures to the new source column of the output data structure.

In some aspects, the techniques described herein relate to a method, wherein the new function is a filter function configured to select a subset of rows from the input data structures based on a filtering condition, and the method further includes: populating the new source column includes, for each row in the output data structure, copying identifiers from a source column of a corresponding row in the input data structures to the new source column of the output data structure.

In some aspects, the techniques described herein relate to a method, wherein the new function is a join function configured for combining data from multiple input data structures, and the method further includes: populating the new source column includes, for each row in the output data structure, aggregating identifiers from source columns of all rows in the input data structures that contribute to the row in the output data structure.

In some aspects, the techniques described herein relate to a method, wherein the new function is a scalar aggregation function configured for computing an aggregate value from multiple rows in the input data structures, and the populating the new source column includes: generating an aggregation identifier representing all rows in the input data structures that contribute to the aggregation; and storing the aggregation identifier in the new source column of the output data structure.

In some aspects, the techniques described herein relate to a method, wherein the identifier for each row includes one or more of: a collection identifier; a function identifier; a table identifier; a partition identifier; a table version identifier; a table name; and a record index.

In some aspects, the techniques described herein relate to a method, wherein the identifier is encoded in a bitmask structure.

In some aspects, the techniques described herein relate to a method, wherein the populating the new source column includes deduplicating identifiers before storing them in the new source column.

In some aspects, the techniques described herein relate to a method, further including: in response to detecting a change to an element in the one or more input data structures, generating an updated output in the output data structure based on the change.

In some aspects, the techniques described herein relate to a method for determining provenance for a data element in a data provisioning network system, the method including: accessing a data structure including a plurality of rows, wherein: each row includes: one or more data elements; an identifier column storing an identifier for the row; a source column storing identifiers of rows from one or more input data structures that contributed to data elements in the row; receiving a request to determine provenance for a target data element in a target row of the data structure; recursively determining provenance for the target data element by: accessing identifiers from the source column of the target row; for each identifier in the source column: identifying a corresponding input data structure and a corresponding input row within the input data structure based on the identifier; when the source column of the corresponding input row is populated, recursively determining provenance for the corresponding input row; and generating a dependency hierarchy for the data element based on the one or more source rows identified through the recursive determination.

In some aspects, the techniques described herein relate to a method, wherein the identifier for each row includes information identifying one or more of: a function that generated the row, a table identifier for the data structure, and a version of the data structure.

In some aspects, the techniques described herein relate to a method, wherein recursively determining provenance for the target data element further includes: for each identifier in the source column of the target row, determining whether the identifier represents an aggregation identifier; and when the identifier represents an aggregation identifier, identifying a corresponding input data structure without matching a specific record index.

In some aspects, the techniques described herein relate to a method, wherein the data structure is associated with a specific data version, and the method further includes determining provenance for the target data element at a historical point in time based on the specific data version.

In some aspects, the techniques described herein relate to a method, further including: receiving a trigger event associated with a function; constructing a dependency graph based on the function, the dependency graph including: a trigger graph identifying functions transitively triggered by the function; and a data dependency graph identifying functions having data dependencies on functions in the trigger graph; resolving version references for data structures associated with functions in the dependency graph; generating an execution plan based on the dependency graph, the execution plan including an ordered sequence of function executions; and executing the functions according to the execution plan.

In some aspects, the techniques described herein relate to a method, wherein constructing the dependency graph includes: adding the function to the trigger graph; recursively adding functions that are transitively triggered by the function to the trigger graph; and representing triggers as trigger arcs between nodes in the trigger graph, wherein each node represents a function.

In some aspects, the techniques described herein relate to a method, wherein the dependency graph is deduced based on identifiers stored in identifier columns and source columns of data structures associated with the functions.

In some aspects, the techniques described herein relate to a method, wherein generating the execution plan includes: determining all functions to execute based on the dependency graph; ordering the functions based on their dependencies; and grouping the functions into one or more transactions based on a transaction strategy.

In some aspects, the techniques described herein relate to a method, wherein the identifier for each row includes one or more of: a collection identifier; a function identifier; a table identifier; a partition identifier; a table version identifier; a table name; and a record index.

In some aspects, the techniques described herein relate to a publish-subscribe data provisioning system including: one or more processors; and a non-transitory computer-readable storage medium including computer program instructions that, when executed by the one or more processors, cause the one or more processors to: receive, from a publisher client device, data for publication to a first data structure, wherein the first data structure includes: for each row in the first data structure, an identifier for the row stored in an identifier column of the first data structure; and for each row in the first data structure, a source column storing identifiers of rows from one or more input data structures that contributed to data elements in the row; receive, from a subscriber client device, a function definition for generating a second data structure dependent on the first data structure; in response to detecting a change to the first data structure: execute the function to generate an updated second data structure, wherein generating the updated second data structure includes: for each row in the updated second data structure, assigning a new identifier to the row and storing the new identifier in an identifier column of the updated second data structure; and for each row in the updated second data structure, populating a source column of the updated second data structure with identifiers for rows in the first data structure that modify data elements in the row of the updated second data structure; and provide the updated second data structure to the subscriber client device.

In some aspects, the techniques described herein relate to a method for maintaining data consistency in a data provisioning network system, the method including: establishing an initial pristine state for a plurality of data structures within the data provisioning network system, wherein the initial pristine state represents a consistent state of the plurality of data structures; identifying a trigger event associated with a triggering function; constructing a dependency graph based on the triggering function, wherein constructing the dependency graph includes: adding the triggering function to the dependency graph, recursively identifying additional functions connected to the triggering function through hierarchical relationships or data dependencies, and adding the identified additional function to the dependency graph; generating an execution plan based on the dependency graph, wherein generating the execution plan includes: determining an ordered sequence of functions to execute based on the dependency graph; and grouping the functions into one or more transactions based on a transaction strategy; executing the functions according to the execution plan within the one or more transactions; committing each transaction of the one or more transactions only when all functions within that transaction complete successfully; and transitioning to an updated pristine state for the plurality of data structures after all transactions in the execution plan complete successfully, wherein the updated pristine state represents a new consistent state of the plurality of data structures.

In some aspects, the techniques described herein relate to a method, wherein constructing the dependency graph includes: accessing identifier columns and source columns of data structures associated with functions in the dependency graph; tracing identifiers stored in the source columns to determine upstream and downstream data structures that contributed to each data structure; and recursively following the identifiers in the source columns across multiple data structures to map data dependencies from original source data through intermediate transformations to output data structures.

In some aspects, the techniques described herein relate to a method, wherein tracing identifiers stored in the source columns includes: for each identifier in a source column of a data structure, extracting information identifying a collection identifier, a function identifier, a table identifier, and a record index; and using the extracted information to locate a corresponding row in an upstream data structure that contributed to the data structure.

In some aspects, the techniques described herein relate to a method, wherein constructing the dependency graph includes: constructing a trigger graph by adding the triggering function to the trigger graph and recursively adding functions that are transitively triggered by the triggering function; and constructing a data dependency graph by adding functions having data dependencies on functions in the trigger graph.

In some aspects, the techniques described herein relate to a method, wherein constructing the dependency graph includes: identifying data version information for each data structure associated with functions in the dependency graph; and using the data version information to determine which specific versions of data structures each function depends upon.

In some aspects, the techniques described herein relate to a method, wherein generating the execution plan includes: resolving relative version references to specific data structure versions based on a latest available version at an execution time; and creating placeholders for future data structure versions that will be generated during execution of the execution plan.

In some aspects, the techniques described herein relate to a method, wherein committing each transaction includes: verifying that all functions within the transaction have completed successfully; making updated data structure versions visible for consumption only after verifying successful completion of all functions within the transaction; and maintaining visibility of previous data structure versions to external consumers until the transaction commits successfully.

In some aspects, the techniques described herein relate to a method, further including: detecting a failure of a function within a transaction; rolling back all data structure versions created within the failed transaction; and failing all dependent transactions that contain functions depending on data structures produced by the failed transaction.

In some aspects, the techniques described herein relate to a method, wherein the transaction strategy includes one of: a function transaction strategy wherein each function executes in its own transaction; a collection transaction strategy wherein functions operating on data structures within a single collection execute within a shared transaction; and a system transaction strategy wherein all functions across all collections execute within a single transaction.

In some aspects, the techniques described herein relate to a method, wherein executing the functions according to the execution plan includes: initiating execution of a downstream function when input data dependencies for the downstream function are satisfied by data structures produced by upstream functions within ongoing transactions; allowing the downstream function to access data structures produced by the upstream functions before the ongoing transactions commit; and maintaining visibility of updated data structure versions to external consumers subject to successful completion of the ongoing transactions.

In some aspects, the techniques described herein relate to a non-transitory computer-readable storage medium including computer program instructions for maintaining data consistency in a data provisioning network system, the computer program instructions, when executed by one or more processors, causing the one or more processors to: establish an initial pristine state for a plurality of data structures within the data provisioning network system, wherein the initial pristine state represents a consistent state of the plurality of data structures; identify a trigger event associated with a triggering function; construct a dependency graph based on the triggering function, wherein constructing the dependency graph includes: adding the triggering function to the dependency graph, recursively identifying additional functions connected to the triggering function through hierarchical relationships or data dependencies, and adding the identified additional function to the dependency graph; generate an execution plan based on the dependency graph, wherein generating the execution plan includes: determining an ordered sequence of functions to execute based on the dependency graph; and grouping the functions into one or more transactions based on a transaction strategy; execute the functions according to the execution plan within the one or more transactions; commit each transaction of the one or more transactions only when all functions within that transaction complete successfully; and transition to an updated pristine state for the plurality of data structures after all transactions in the execution plan complete successfully, wherein the updated pristine state represents a new consistent state of the plurality of data structures.

In some aspects, the techniques described herein relate to a non-transitory computer-readable storage medium, wherein constructing the dependency graph causes the one or more processors to: access identifier columns and source columns of data structures associated with functions in the dependency graph; trace identifiers stored in the source columns to determine upstream and downstream data structures that contributed to each data structure; and recursively follow the identifiers in the source columns across multiple data structures to map data dependencies from original source data through intermediate transformations to output data structures.

In some aspects, the techniques described herein relate to a non-transitory computer-readable storage medium, wherein tracing identifiers stored in the source columns causes the one or more processors to: for each identifier in a source column of a data structure, extract information identifying a collection identifier, a function identifier, a table identifier, and a record index; and use the extracted information to locate a corresponding row in an upstream data structure that contributed to the data structure.

In some aspects, the techniques described herein relate to a non-transitory computer-readable storage medium, wherein constructing the dependency graph causes the one or more processors to: construct a trigger graph by adding the triggering function to the trigger graph and recursively adding functions that are transitively triggered by the triggering function; and construct a data dependency graph by adding functions having data dependencies on functions in the trigger graph.

In some aspects, the techniques described herein relate to a non-transitory computer-readable storage medium, wherein constructing the dependency graph causes the one or more processors to: identify data version information for each data structure associated with functions in the dependency graph; and use the data version information to determine which specific versions of data structures each function depends upon.

In some aspects, the techniques described herein relate to a non-transitory computer-readable storage medium, wherein generating the execution plan causes the one or more processors to: resolve relative version references to specific data structure versions based on a latest available version at an execution time; and create placeholders for future data structure versions that will be generated during execution of the execution plan.

In some aspects, the techniques described herein relate to a non-transitory computer-readable storage medium, wherein committing each transaction causes the one or more processors to: verify that all functions within the transaction have completed successfully; make updated data structure versions visible for consumption only after verifying successful completion of all functions within the transaction; and maintain visibility of previous data structure versions to external consumers until the transaction commits successfully.

In some aspects, the techniques described herein relate to a non-transitory computer-readable storage medium, wherein the computer program instructions, when executed by the one or more processors, further cause the one or more processors to: detect a failure of a function within a transaction; roll back all data structure versions created within the failed transaction; and fail all dependent transactions that contain functions depending on data structures produced by the failed transaction.

In some aspects, the techniques described herein relate to a non-transitory computer-readable storage medium, wherein executing the functions according to the execution plan causes the one or more processors to: initiate execution of a downstream function when input data dependencies for the downstream function are satisfied by data structures produced by upstream functions within ongoing transactions; allow the downstream function to access data structures produced by the upstream functions before the ongoing transactions commit; and maintain visibility of updated data structure versions to external consumers subject to successful completion of the ongoing transactions.

In some aspects, the techniques described herein relate to a data provisioning network system including: one or more processors; and a non-transitory computer-readable storage medium including computer program instructions that, when executed by the one or more processors, cause the one or more processors to: establish an initial pristine state for a plurality of data structures within the data provisioning network system, wherein the initial pristine state represents a consistent state of the plurality of data structures; identify a trigger event associated with a triggering function; construct a dependency graph based on the triggering function, wherein constructing the dependency graph includes: adding the triggering function to the dependency graph, recursively identifying additional functions connected to the triggering function through hierarchical relationships or data dependencies, and adding the identified additional function to the dependency graph; generate an execution plan based on the dependency graph, wherein generating the execution plan includes: determining an ordered sequence of functions to execute based on the dependency graph; and grouping the functions into one or more transactions based on a transaction strategy; execute the functions according to the execution plan within the one or more transactions; commit each transaction of the one or more transactions only when all functions within that transaction complete successfully; and transition to an updated pristine state for the plurality of data structures after all transactions in the execution plan complete successfully, wherein the updated pristine state represents a new consistent state of the plurality of data structures.

### BRIEF DESCRIPTION OF DRAWINGS

Figure (FIG.) 1 illustrates a system environment for a table-based data provisioning system, according to an example embodiment.

FIG. 2 is a block diagram of an example client device, in accordance with one embodiment.

FIG. 3 illustrates a network system, according to an example embodiment.

FIG. 4 illustrates a transaction based execution plan, according to an example embodiment

FIG. 5 illustrates a workflow of network system executing an execution plan and maintaining a consistent state of data tables within system environment, according to an example embodiment.

FIG. 6 illustrates a dependency graph for a data function, according to an example embodiment.

FIG. 7A illustrates version management for a single function within a transaction, according to an example embodiment.

FIG. 7B illustrates a timing diagram for the function execution and version management shown in FIG. 7A, according to an example embodiment.

FIG. 8A illustrates version management for multiple functions within a collection transaction, according to an example embodiment.

FIG. 8B illustrates a timing diagram for the multiple function execution and version management shown in FIG. 8A, according to an example embodiment.

FIG. 9 illustrates a workflow of network system tracking lineage and provenance for data tables, according to an example embodiment.

FIG. 10 illustrates provenance tracking for projection and filtering operations, according to an example embodiment.

FIG. 11 illustrates provenance tracking for join operations, according to an example embodiment.

FIG. 12 illustrates provenance tracking for aggregation operations, according to an example embodiment.

FIG. 13 is a workflow diagram for generating an output data structure with provenance tracking, according to an example embodiment.

FIG. 14 is a workflow diagram for determining provenance for a data element in a data structure, according to an example embodiment.

FIG. 15 is a workflow diagram for provisioning data in a publish-subscribe data provisioning system with provenance tracking, according to an example embodiment.

FIG. 16 is a workflow diagram for maintaining data consistency through pristine state transitions in a data provisioning network system, according to an example embodiment.

FIG. 17 is a block diagram illustrating components of an example machine for reading and executing instructions from a machine-readable medium.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

A network system that decouples data producers and consumers in a publish-subscribe data provisioning system is described. Generally, the network system strives to reduce or eliminate integration complexity. It combines the advantages of virtualization (e.g., allowing domain teams to publish and manage their data) with the scalability and efficiency of data movement systems, delivering data directly to consumers.

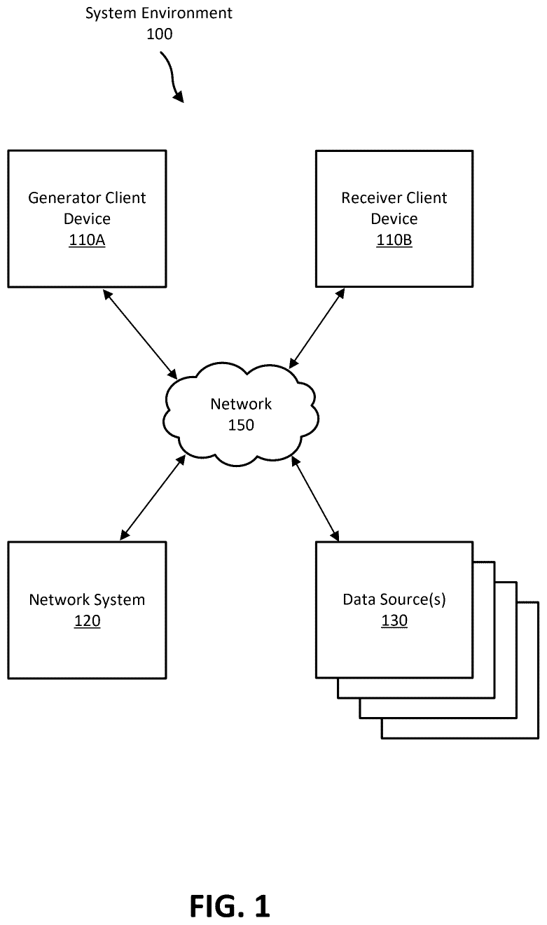

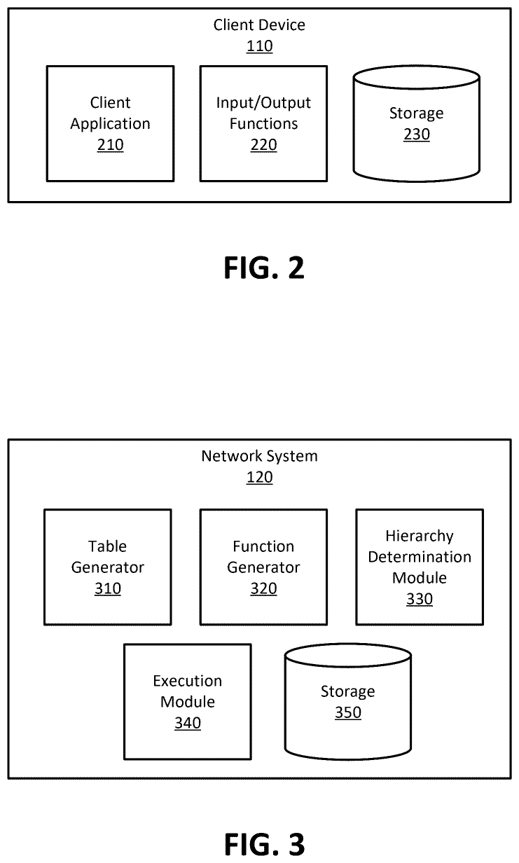

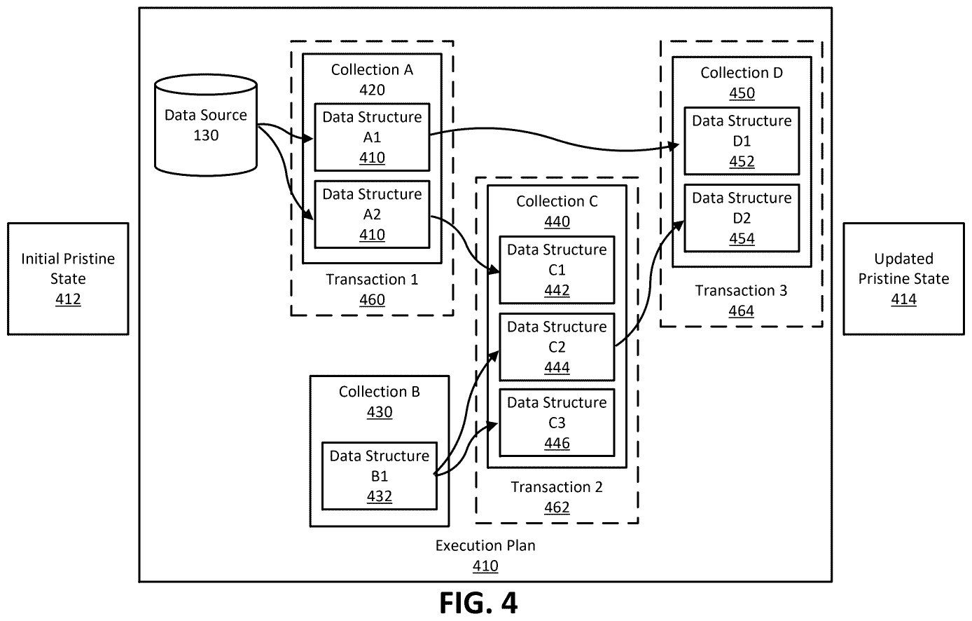

The network system operates on the abstraction of tables, enabling the creation of derived tables that span multiple data sources. This approach enhances semantic cohesion, reduces errors, improves data quality, and facilitates self-service data access across domains. Its architecture also supports complete lineage tracking of tables and record-level provenance, enhancing transparency and visibility. Embodiments relate to determining a treatment and a treatment configuration for an autonomous or semi-autonomous farming machine such that it can implement farming actions to accomplish a farming objective in a field. FIGS. 1-2 describe general information related to example farming machines. FIGS. 3-4 describe example implementations of a multimode autonomous farming machine that autonomously changes between treatment configurations based on a variety of operating environment factors and characteristics to perform farming action that accomplish a farming objective.

### II. Traditional Solutions

### Data Management

As organizations evolve, so do their internal domains, each focusing on specific aspects of business and operations. These domains generate and interact with vast amounts of data from various sources, making the seamless combination and alignment of this data crucial. Effective data integration ensures operational efficiency, drives informed decision-making, and maintains a competitive edge. It supports use cases ranging from enhancing customer experiences and improving operational workflows to meeting regulatory compliance requirements. The ability to integrate data at scale becomes increasingly important as organizations grow and expand their operations.

Data integration solutions span a spectrum, from manual data aggregation to sophisticated, real-time, large-scale, multi-source integration systems equipped with governance, security, automation, and self-correcting capabilities. Broadly, these solutions fall into two categories: data virtualization systems and data movement systems. The primary difference between these systems lies in where the data resides when ready for consumption.

Data virtualization systems create a virtual view of data stored in disparate source systems, achieving integration without physically moving the data. Federated query engines are an example, allowing users to create queries without worrying about the data's location. These systems translate user queries into physical queries sent to the source systems, combining the results into a unified virtual view. By contrast, data movement systems copy data from source systems into an external repository, such as a cloud data warehouse for consumption. These systems often transform the data into more suitable formats and structures during the data transfer process.

Each approach has its strengths and limitations. Data virtualization systems excel in maintaining high data quality and semantic cohesion because data remains under the stewardship of domain teams. However, they are constrained by the availability and performance of the source systems, making them less effective for large-scale analytical workloads. Data movement systems, on the other hand, offer complete decoupling of data sources from consumption systems, enabling historical data analysis and regulatory compliance use cases. However, they require significant engineering effort to manage and risk introducing data drift or semantic drift over time.

This dichotomy forces organizations to compromise, choosing between the benefits of virtualization and movement systems while managing their associated costs. This challenge highlights the need for a unified solution that combines the strengths of both approaches while minimizing their drawbacks. The network system proposed below addresses these limitations through a table-based architecture that differs fundamentally from existing data virtualization and data movement approaches.

### Generator-Receiver Models

Generator-receiver, or publisher-subscriber, models are traditionally used to provision data between generators and receivers. A generator generates data, and a receiver that follows the generator receives that data when it is generated. This “pub-sub” communication model has been a cornerstone of distributed systems for nearly four decades, evolving into an essential pattern for exchanging data between message producers and consumers. Initially designed as a messaging paradigm, its applications span diverse use cases such as real-time log aggregation, gaming, IoT network communication, monitoring, and observability. The pub-sub model's flexibility and scalability have cemented its role in modern enterprise architectures.

At the heart of pub-sub-based systems are messaging systems. These platforms facilitate the efficient exchange of messages or events between producers and consumers and have become foundational components in enterprise technology stacks. Over time, the adoption of messaging systems has led to the development of specialized compute systems that operate directly on top of event streams to enable focused capabilities such as real-time analytics and edge computing.

Streaming database systems were the next evolutionary step, providing even greater specialization and utility for pub-sub architectures. Platforms enabled declarative querying of real-time data streams. Similarly, some systems support incrementally updated materialized views, allowing users to maintain continuously updated results as data evolves. A hallmark feature of these systems is the notion of continuous queries, which operate within a stream context to deliver incremental updates as new data flows through the underlying messaging system. These systems exemplify how pub-sub principles have been extended beyond basic messaging to support advanced functionalities such as real-time analytics and event-driven workflows.

Beyond streaming systems, some platforms provide pub-sub-like functionality through features that capture, create, update, and delete operations on rows or tables. Such mechanisms enable real-time data synchronization but often operate at the level of individual records or transactions, aligning more closely with change data capture (CDC) techniques. These record-level approaches lack the table-centric abstraction and provenance tracking capabilities of the system described herein.

Further, some platforms enable workflow orchestrators, which offer a means to simulate pub-sub-like exchanges by managing task dependencies and execution flows. These systems enable workflows where upstream tasks can trigger downstream ones based on conditions or schedules, mimicking aspects of a pub-sub model. However, their primary focus is on orchestrating processes rather than managing data, which positions them differently from systems aimed explicitly at data integration. Workflow orchestrators do not provide the integrated provenance tracking and transactional consistency mechanisms described in the present system.

Some examples are metadata systems within data lakes that offer capabilities which can approximate pub-sub-like workflows. These platforms facilitate atomic updates to tables, ensuring data quality and consistency. However, these approaches are inherently tied to data lakes and are not optimized for integrating raw data originating from external systems. Moreover, such systems do not provide the row-level provenance tracking through identifier and source columns that enables bidirectional traceability in the present invention.

While all of these systems excel in working with streams, their fundamental unit of operation remains tied to individual records or units of work. Messaging systems underpin the exchange of messages, while higher-order systems build on these principles to provide focused capabilities such as declarative querying, stream analytics, data synchronization, or workflow coordination. The system described herein takes a different approach by using tables as the fundamental unit of operation, with each row containing identifier and source columns that maintain complete provenance information.

Rather than focusing on messages, events, or workflows, the system below enables pub-sub workflows centered around tables with integrated provenance tracking, emphasizing data integration from data source systems rather than messaging, workflow orchestration, or the internal management of data in data lakes. As a result, it complements existing paradigms while addressing gaps in integrating and managing data across organizational and technical boundaries through novel provenance mechanisms not found in traditional pub-sub or data integration systems.

### III. Table Based Data Provisioning System

The systems and methods disclosed herein provide an innovative data integration middleware that employs a generator-receiver (e.g., publish-subscribe or pub-sub) model for tables. Domain teams generate data from source systems using executable code and libraries, while operational and analytics teams receive these tables. Operational and analytical teams may be referred to as receivers. The receivers may move data directly into their systems of choice from the generator based on the tables. This dynamic system not only allows for direct table publication and subscription but also enables users to overlay complex transformations and models using, e.g., development environment APIs (e.g., Python-based DataFrame application programming interfaces (APIs)), executed in a controlled environment.

By leveraging the architectures proposed herein, organizations can achieve many benefits. For example, data remains under the stewardship of domain teams, reducing the risk of data and semantic drift while ensuring high-quality datasets. Complex data models and transformations can be built and maintained seamlessly, supporting semantic cohesion across domains. The system captures data states as a series of commits, akin to source control systems, enabling historical queries, full data provenance, and reproducibility.

The systems and methods described herein address the technical problem of maintaining data consistency and provenance across distributed data integration workflows by providing a technical solution comprising a table-based architecture with embedded provenance tracking. Specifically, the system solves the technical challenge of tracking data lineage across complex transformations by storing, in each row of every data structure, an identifier column and a source column containing identifiers of contributing rows from input data structures. This technical mechanism enables automated, bidirectional traceability of data origins and transformations without requiring external metadata systems or manual tracking processes. The architecture further addresses the technical problem of ensuring transactional consistency across multi-source data updates by implementing function transactions, collection transactions, and system transactions that guarantee atomic updates and prevent partial state inconsistencies. These technical solutions enable the system to maintain data integrity and complete provenance information across large-scale, distributed data integration operations.

### System Environment

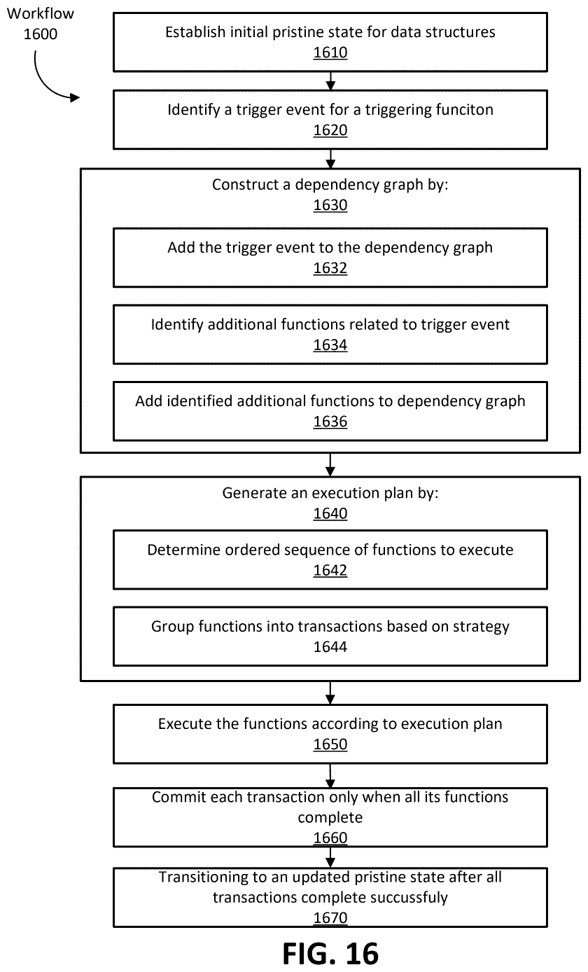

Turning now to FIG. 1, it illustrates a system environment for a table-based data provisioning system according to an example embodiment. The system environment 100 includes a generator client device 110A, a receiver client device 110B, a network system 120, data sources 130, and a network 140. In various embodiments, there may be one or more generator client device 110A (not pictured), one or more receiver client device 110B, etc. Additionally, in some configurations, the functionality of one element may be provided by another element, the functionality of various elements may be combined, etc. For instance, in some configurations, generator client device 110A and/or receiver client device 110B may include the functionality of network system 120. Similarly, generator client device 110A may include the functionality of receiver client device 110B and vice versa. Still further, one or more elements of system environment 100 may provide functionality to other elements via, e.g., an application programming interface, or, e.g., as commands in a code library. It is noted that the client devices and the network system may include some or all of the components of a computer system as described with FIG. 16.

At a high level, the system environment 100 enables a data source 130 to generate data for provisioning to devices in the system environment 100. For example, generator client device 110A generates a data structure representing data from a data source 130 using network system 120 (e.g., a data table). As the external data source 130 modifies the data, the generator client device 110A continuously modifies the data table to reflect those modifications. Network system 120 tracks the evolution of the data table for use in provisioning the data to other devices.

Receiver client device 110B monitors the table generated by generator client device 110A by, e.g., subscribing to, referencing, etc., that data table. Receiver client device 110B may use the data table to provision an external data source 130 with data represented in the data table. In other words, network system 120 facilitates generator client device 110A providing data to receiver client device 110B using a data table as the data represented in that table (from a data source) is changed. Either generator client device 110A or receiver client device 110B may dictate how data is transferred using various methodologies (e.g., receiver client device 110B requesting the data from data source 130), some of which are described hereinbelow. Data is transferred from between elements in the system environment 100 via a network 140 (e.g., from generator client device 110A to receiver client device 110B, from a first data source 130 to a second data source 130, etc.).

Within system environment 100, data stored in data source 130 is represented as a data table. The data table is a data structure comprising rows and columns with entries corresponding to the data in the data source 130.

Each data table includes multiple columns that serve distinct purposes in maintaining data integrity and provenance tracking. A first column (e.g., an identifier column) stores an identifier for each row. The identifier uniquely identifies the row. The identifier may include information such as a collection identifier, a function identifier, a table identifier, a partition identifier, a table version identifier, a table name, a record index, and the like. This identifier enables the system to track each row across transformations and updates within the system environment 100.

A second column (e.g., a source column) stores source information for each row. The source information comprises identifiers of rows from other data tables that contributed to data elements in the current row or affected data elements in the current row. These identifiers maintain provenance information, linking data elements in the current row to their origins in input data structures. The source column enables bidirectional traceability, allowing the system to determine both upstream dependencies and downstream usage of data.

One or more additional columns store data elements. Data elements may include numerical values, text strings, timestamps, Boolean values, or other data types relevant to the application domain. For example, in a financial application, data elements may include asset prices, transaction volumes, entity identifiers, or calculated metrics. In other domains, data elements may include sensor readings, user identifiers, product information, or any other structured data relevant to the system's purpose.

In alternative embodiments, the identifier and source information need not be stored as distinct columns within the data structure. The identifier and source information may be attached as metadata associated with each row, stored in a separate metadata structure that references rows in the data structure, or maintained in an auxiliary data store that links to the primary data structure through row references. The identifier and source information may also be encoded within a header or footer section of the data structure, embedded as annotations within the data structure format, or stored using any other method that maintains the association between each row and its corresponding identifier and source information while enabling the system to retrieve and utilize this information for provenance tracking and dependency resolution.

Data tables may be organized into collections. A collection may be a logical grouping of related data tables that share a common domain or context. For example, in a financial application, one collection may include tables for transaction headers, transaction line items, and payment records, while another collection may include tables for customer profiles, account balances, and credit histories. In a manufacturing application, one collection may include tables for inventory levels, warehouse locations, and stock movements, while another collection may include tables for production schedules, machine utilization, and quality control metrics.

Within system environment 100, data tables may operate in a publish-subscribe ecosystem where subscriber client devices can subscribe to data at multiple levels of granularity. A subscriber client device may subscribe to individual data elements within specific rows, enabling fine-grained monitoring of particular values. A subscriber client device may subscribe to entire rows, receiving updates whenever any data element in those rows changes. A subscriber client device may subscribe to entire tables, receiving updates whenever any row in the table is modified. A subscriber client device may subscribe to entire collections, receiving updates whenever any table within the collection changes. A subscriber client device can subscribe to one or more data elements, rows, tables, collections, etc.

As an example of the publish-subscribe system in operation, consider a distributed sensor network where multiple sensor devices generate measurement data. A first generator client device 110A publishes sensor readings to a first data table, with each row representing a timestamped measurement from a particular sensor. A transformation function processes the first data table to generate a second data table containing aggregated statistics over time windows. A second generator client device 110A publishes configuration parameters to a third data table. A receiver client device 110B subscribes to the second data table to receive the aggregated statistics for display on a monitoring dashboard. When new sensor readings arrive at the first data table, the network system 120 automatically executes the transformation function to update the second data table, and the updated data propagates to the receiver client device 110B through the subscription mechanism.

Data tables in the system environment 100 are managed and manipulated using functions. A function controls how data is translated between data tables, generator client device 110A, and receiver client device 110B, and therefore how data is moved throughout system environment 100. Functions can take many different forms, some of which are described herein.

In a first example, a function is a generator function. A generator function maps data from a data source 130 to a data table. The generator function extracts data from an external data repository, storage on a client device, or other data source, and structures that data into rows and columns of the data table. Each row generated by the generator function receives a unique identifier stored in the identifier column. The generator function populates the source column of each row with identifiers indicating the origin of the data in the external data source. For instance, client device 110 may leverage a generator function to map a listing of inventory and their prices from an external database to a data table, where each inventory item becomes a row with columns for item name, price, and quantity.

In a second example, a function is a receiver function. A receiver function maps data from a data table to a data source 130. The receiver function reads rows from the data table and writes corresponding data to an external data repository, storage on client device 110, or other destination system. The receiver function may transform the data format during the transfer to match the requirements of the destination system. The receiver function may selectively transfer only certain rows or columns based on filtering criteria. For example, client device 110 may leverage a receiver function to map the data table describing the listing of inventory to a cloud storage system, transferring only items with prices above a threshold value.

In a third example, the function is a transformation function. A transformation function maps data from one or more tables (e.g., input tables) to one or more tables (e.g., output tables). The transformation function reads rows from the input data tables, performs operations on the data elements, and generates new rows in the output data table. The transformation function assigns new identifiers to rows in the output data table and populates the source column with identifiers of rows from the input data tables that contributed to each output row.

Transformation functions may operate on data tables in several distinct ways. Transformation operations may be combined and applied on top of one another.

A projection function may perform operations on columns such as mathematical calculations and combine multiple columns to create a new column, for example concatenating their string values.

A filter function selects a subset of rows from an input data table based on a filtering condition. The filter function evaluates the filtering condition for each row in the input data table and includes only those rows that satisfy the condition in the output data table.

A join function combines data from multiple input data tables. The join function identifies rows across the input data tables that share common values in a subset of columns (typically referred to as join columns) and creates new rows in the output data table containing data elements from the matched rows.

An aggregation function computes aggregate values from multiple rows in an input data table. The aggregation function groups rows based on specified grouping columns and applies an aggregation operation to data elements within each group. Aggregation operations include sum, count, average, minimum, maximum, and other statistical functions.

Additionally, within system environment 100, data tables and their corresponding functions create a dependency hierarchy. A dependency means at least some portion of data in a table is dependent on another data table or data source 130. Stated differently, a dependency indicates that data in a dependent table will change if data in the table on which it depends changes. Dependency within the hierarchy may be described by a function definition that declares the data table dependency for the function. In some examples, dependencies are structured into a table using annotations in the function definition code that specify which data tables or data sources the function depends upon.

There are a variety of dependencies available in the dependency hierarchy. In a first example, the dependency hierarchy includes an internal dependency. An internal dependency indicates that a first table is dependent on a second table. In a second example, the dependency hierarchy includes an external dependency. An external dependency indicates that a table is dependent on an external data source 130. Other examples are also possible.

The various data tables, functions, and dependencies create a dependency graph for each data table. The dependency graph defines the various relationships between the data table and other data tables and data sources 130 within the system environment 100 given the functions and dependencies therein. With this, network system 120 can generate execution plans using data graphs within system environment 100. An execution plan is a dependency driven sequence of function executions within a data graph to accomplish a data transformation and provision.

Execution plans may be executed in response to an execution trigger. An execution trigger is an event or condition that initiates the execution of a function or sequence of functions within the system environment 100. The network system 120 monitors for execution triggers and responds by generating and executing the corresponding execution plan.

Execution triggers may take several forms. In a first example, an execution trigger comprises a change in a data source 130. When data in an external data source 130 is modified, added, or deleted, the network system 120 detects this change and triggers execution of functions that depend on that data source. In a second example, an execution trigger comprises a change in a data table. When a generator function or transformation function updates a data table, the network system 120 identifies downstream functions that depend on that table and triggers their execution. In a third example, an execution trigger comprises a command from a user of client device 110. A user may manually initiate execution of a function through a user interface or programmatic command.

Execution triggers may also be time-based or schedule-based. The network system 120 may execute functions at predetermined intervals, such as hourly, daily, or weekly. Execution triggers may be condition-based, where execution occurs when specific conditions are met, such as when a data element exceeds a threshold value or when multiple data sources have all been updated. Execution triggers may be event-based, responding to external events such as API calls, webhook notifications, or messages from external systems.

Execution system 120 may also leverage versioning when generating dependencies and dependency hierarchies. That is, each data table may have one or more versions, where each version represents a different iteration of data in that table. Any function corresponding to that table may have a dependency linked to a particular version of that table. For instance, the dependency may be based on “the most recent version of the table,” “the oldest version of the table,” “tables between Time A and Time B,” etc. In this manner, receiver client device 110B can control which version of data they wish to receive and/or how their data is updated.

Additionally, network system 120 employs various methodologies to ensure data integrity.

In a first example, network system 120 employs function transactions when executing an execution plan. Function transactions induce atomic updates for all tables associated with an individual function, such as a generator or transformer. When a function executes, the network system 120 begins a transaction, performs all read and write operations for that function within the transaction scope, and commits the transaction only when all operations complete successfully. If any operation fails, the network system 120 rolls back the entire transaction, ensuring that no partial updates persist in the output tables.

In a second example, network system 120 employs collection transactions. Collection transactions induce atomic updates for all tables within a single collection when executing multi-collection plans. When multiple functions operate on tables within the same collection, the network system 120 groups those functions into a single transaction. All functions within the collection transaction execute, and their output tables are updated atomically. The network system 120 commits the collection transaction only when all functions within the collection complete successfully, ensuring that all tables in the collection reflect a consistent state.

In a third example, network system 120 employs system transactions. System transactions enable atomic updates for complex, multi-collection execution workflows across network system 120. When an execution plan spans multiple collections, the network system 120 can execute all functions across all collections within a single system-wide transaction. The network system 120 commits the system transaction only when all functions in the execution plan complete successfully across all collections, ensuring that the entire system transitions from one consistent state to another consistent state atomically.

The network system 120 may organize execution plans based on the selected transaction strategy. For function transactions, as an example, the execution plan groups each function into its own transaction boundary, allowing functions to commit independently as they complete. For collection transactions, as an example, the execution plan groups all functions operating on tables within each collection into collection-level transaction boundaries, with each collection committing independently. For system transactions, the execution plan encompasses all functions across all collections within a single transaction boundary.

To illustrate, consider an execution plan involving three collections: a sales collection, an inventory collection, and a fulfillment collection. Under function transactions, each function updating tables in these collections commits independently. Under collection transactions, all functions updating sales tables commit together, all functions updating inventory tables commit together, and all functions updating fulfillment tables commit together. Under system transactions, all functions across all three collections commit together as a single atomic operation, ensuring that sales, inventory, and fulfillment data all reflect the same consistent business state.

Overall, the architecture of data tables, functions, data graphs, triggers, execution plans, etc. within system environment 100 create a system architecture that provides a powerful, table-centric data integration solution. As such, network system 120 offers flexibility, consistency, and seamless propagation of changes across large-scale dependency graphs. Its combination of programmability, version-controlled tables, and robust transaction strategies provides a solid foundation for tackling modern data integration challenges.

FIG. 2 is a block diagram of an example client device 110, in accordance with one embodiment. The client device 110 may be the client device 110A and/or 110B. The client device 110 includes a client application 210, input and receiver functions 220, and storage 230. The client device 110 may include additional or fewer modules, and the illustrated modules may provide functionality different than what is described herein. Moreover, functionality of one element of client device 110 may be provided by a different element of client device 110, or by some other element in system environment 100.

Client device 110 includes client application 210. At a high level, client application 210 provides functionality for allowing data to be mapped to and between data structures, and the corresponding provisioning of the data based on the data structures (e.g., data tables), using the data architecture described hereinabove. Client application 210 can function in different manners, depending on the configuration of client device 110.

In an example configuration, some of the functions of the network system 120 may be executed locally on the client device 110. For example, in some cases, functionality of network system 120 may be provided to client device 110 as a library for a development environment (e.g., a library that may be used to generate a script for Python). In this case, a user of the client device may utilize commands in the library that, when executed by client device 110 within system environment 100, provide functions enabled by network system 120. For instance, a user of client device 110 may create an executable script using functions from a library developed by network system 120. The script, when executed by client device 110, performs functions enabled by the network system 120 such as structuring generated data in a data structure format, and transmitting data between devices based on data in a data structure format.

Other configurations are also feasible. For instance, in an example configuration, the client application 210 is an application used to provide the services of the network system 120 when its services are located on a remote server. Additionally, in an example configuration, client application 210 is an API that provides access to functionality of network system 120 when its services are located on a remote server.

Client device 110 includes various input/receiver functions 220, which may include, e.g., functions of input devices such as keyboards, touchscreen displays, microphones, etc. The storage 230 may store data generated by client device 110 and/or received via the network 140.

### Example Network System

FIG. 3 illustrates a network system 120, according to an example embodiment. In the illustrated example, network system 120 includes a table generator 310, a function generator 320, a hierarchy determination module 330, an execution module 340, and a storage 350. The network system 120 may include additional or fewer modules, and the illustrated modules may provide functionality different than what is described herein. Moreover, functionality of one element of network system 120 may be provided by a different element of network system 120, or by some other element in system environment 100.

Network system 120 includes table generator 310. Table generator 310 inputs data from an outside source (e.g., data source 130) and maps it to a data table within network system 120 (e.g., in storage 350). When generating the data table, table generator 310 may structure the table to adhere to the input data and/or structure the input data to adhere to the created table. In generating data tables, table generator 310 may structure a data table with information or metadata allowing those tables to be accurately referenced by functions, data graphs, execution plans, etc.

Table generator 310 may also create data tables based on function definitions received from client devices or other components of network system 120. When a function definition specifies output data structures, table generator 310 generates the corresponding data tables with appropriate columns, including identifier columns and source columns for provenance tracking. Table generator 310 configures these tables according to the function's requirements, ensuring that the table structure supports the operations defined by the function. The generated tables are then available for use by the function during execution.

As an example, consider a distributed sensor network deployed across multiple manufacturing facilities. Table generator 310 receives sensor measurement data from an external data source 130 comprising temperature readings, pressure values, and humidity levels collected from sensors in different facility zones. Table generator 310 creates a data table with columns for sensor identifier, zone location, measurement type, measurement value, and timestamp, structuring each sensor reading as a row with a unique identifier in the identifier column and populating the source column with references to the external data source. Subsequently, a transformation function definition specifies computation of hourly average temperatures for each zone. Table generator 310 creates an output data table resulting from this function with columns for zone location, average temperature, and time window, configuring the table structure to support the aggregation operation defined by the function.

Network system 120 includes function generator 320. Function generator 320 generates functions for inputting data to data tables from data sources 130, outputting data from data tables to data sources 130, and mapping information between data tables. To generate a function, network system 120 may receive an input from a user and create the corresponding function (e.g., a command, an executable input, etc.). Function generator 320 can generate one or more functions for each data table, and each function may have one or more triggers. Typically, a trigger is a change in data from a data table connected by a function but could be some other trigger. In generating functions, function generator 320 may append various data or metadata to data tables to allow efficient operation of functions within system environment 100.

Network system 120 includes hierarchy determination module 330. Hierarchy determination module 330 inputs data tables and their associated functions and generates dependency graphs. A dependency graph defines the various dependencies between a data table and other data tables and functions within system environment 100. The dependency graph captures both trigger relationships, where execution of one function initiates another, and data dependencies, where functions require specific versions of input data tables.

Hierarchy determination module 330 constructs dependency graphs by analyzing function definitions to determine data dependencies and execution order. For each function, the module examines the function definition to identify which tables the function depends on for data input and which tables the function produces as output. The hierarchy determination module 330 also identifies trigger dependencies, determining which functions trigger execution of other functions. Using this information from function definitions, hierarchy determination module 330 calculates both a data dependency graph and an execution graph. The data dependency graph defines which table versions each function will consume, ensuring that any table version dependency produced by a function in the execution graph is already available before dependent functions begin executing. The execution graph defines the order of function execution, establishing a sequence that respects all data dependencies and trigger relationships. This analysis enables the module to construct a comprehensive dependency graph representing all execution and data dependency relationships within system environment 100.

Network system 120 includes execution module 340. Execution module 340 generates an execution plan. The execution plan is an ordered sequence of functions and data table manipulations that propagate changes made in a data source to any data tables depending on that data source.

### State Management and Execution Plans

As noted above, network system 120 includes various methodologies that enable correctness and consistency in data management by treating every data table version as immutable and version controlled. Each execution of a function (whether a generator, transformer, or receiver) creates a new version of its output tables, updating them atomically. This guarantees that functions either produce a complete, consistent update or no update at all, eliminating the possibility of partial updates.

Moreover, the architecture of network system 120 supports consistent state management, allowing synchronization of related tables. For example, if invoice data consists of both a header and an item table, network system 120 updates the data tables in tandem, reflecting the same version. This principle extends to complex workflows where multiple functions produce interdependent tables, such as invoices, inventory, and customer data. Network system 120 maintains data correlation across all dependencies to provide a unified, consistent state for consumption.

Achieving consistent state of data tables leverages the architecture described above and the corresponding dependency-driven execution model. Users specify dependencies to table versions, outputs, and triggers for each function. Triggers, which can be manual, programmatic, or based on updates to other tables, initiate the function's execution. Network system 120 automatically resolves dependencies, calculates execution plans, and ensures that updates propagate across the entire dependency graph, maintaining consistency without imposing undue complexity on users.

Network system 120 uses execution plans to orchestrate refresh workflows. These plans determine the order in which functions are executed, resolving all dependencies to allow for data consistency. Each plan is assigned a unique timestamp, establishing a strict and deterministic execution order. Functions can be executed in parallel as long as their input dependencies are satisfied, allowing network system 120 to balance efficiency with correctness.

As noted above, to further guarantee consistency, network system 120 operates within a transactional framework. With function transactions, each function operates in its own transaction, ensuring atomic updates for its tables. With collection transactions, functions within a single collection execute under a shared transaction, maintaining atomicity at the collection level. With system transactions, all functions across collections execute within a single transaction, ensuring system-wide atomic updates.

This transactional design ensures that network system 120 moves seamlessly between consistent states, whether updates involve a single table, a collection, or the entire system. Any failure during a transaction results in a rollback, ensuring no partial updates compromise consistency.

Network system 120 also supports deterministic data access to provide a consistent view of tables. Users (e. g,, via user client devices) may query table versions by specifying a timestamp, ensuring that all accessed data corresponds to a single, unified state.

By combining immutability, versioning, and an intelligent execution model, network system 120 enables organizations to maintain correctness and consistency across complex data integration workflows, simplifying operations while ensuring reliability.

As an example, FIG. 4 illustrates a transaction based execution plan, according to an example embodiment. The execution plan 410 demonstrates how network system 120 maintains data consistency through transactional boundaries during function execution. The system begins in an initial pristine state 412, representing a consistent state of all data structures before execution commences. The execution plan 410 comprises multiple transactions, including transaction 1 460, transaction 2 462, and transaction 3 464, each operating on different collections of data structures within the system environment 100.

Transaction 1 460 operates on collection A 420, which includes data structure A1 410 and data structure A2 (410). Data source 130 provides input data to collection A 420, and the functions within transaction 1 process this data to update the data structures within the collection.

Transaction 2 462 operates on collection B 430, using data from collection A 420 and collection B 430. Collection B includes data structure B1 432 and collection C includes data structure C1 442, data structure C2 444, and data structure C3 446.

Transaction 3 464 operates on collection D 450 using data from collection A 420 and collection C 440. Collection D includes data structure D1 452 and data structure D2 454.

In this execution plan 410, each transaction executes its functions atomically, ensuring that all data structures within the transaction's scope are updated consistently or not at all.

The system transitions to the updated pristine state 414 only when all transactions within the execution plan 410 complete successfully. If any transaction fails during execution, network system 120 rolls back all changes made within that transaction and any dependent transactions, ensuring that the system remains in a consistent state.

This transactional architecture guarantees that data consumers always observe consistent states, never encountering partially updated data structures. The pristine states 412 and 414 represent stable, queryable states of the system where all data structures reflect internally consistent business logic and data relationships.

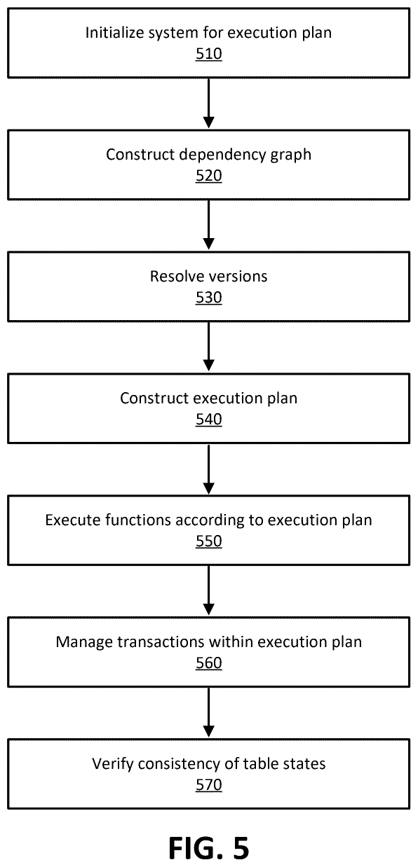

FIG. 5 illustrates a workflow of network system 120 executing an execution plan and maintaining a consistent state of data tables within system environment 100, according to an example embodiment. The workflow may include additional or fewer elements, elements may occur in a different order, or elements may be repeated, depending on the configuration of system environment 100.

Network system 120 initializes 510 system environment 100 for construction and execution of an execution plan. The initialization process establishes the foundational parameters that ensure deterministic and reproducible execution across the distributed system. To do so, network system 120 may assign a system-wide unique execution time (T) to the execution plan, which provides a strict, deterministic ordering that enables consistent resolution of data dependencies and version references. This timestamp serves as a global reference point for all operations within the execution plan, allowing all components of the system to observe a consistent view of function execution and data versions. Network system 120 identifies a function F (e.g., a triggering function) that initiates the execution plan, establishing the starting point for dependency resolution and execution sequencing.

Network system 120 constructs 520 a dependency graph representing the complete set of functions and data dependencies involved in the execution plan. The dependency graph comprises two interconnected components: a trigger graph and a data dependency graph.

The trigger graph captures the execution flow relationships between functions, where one function's completion triggers the execution of downstream functions. Network system 120 adds the triggering function F to the trigger graph and recursively adds all functions that are transitively triggered by F, building a complete representation of the execution cascade. Network system 120 represents these trigger relationships as directed arcs between nodes in the graph, where each node represents a function.

The data dependency graph captures the data flow relationships, identifying which functions consume data produced by other functions. For the data dependency graph, network system 120 examines each function in the trigger graph to identify its input data tables, then adds functions to the graph that have data dependencies on tables produced by functions already in the graph. These data dependencies are represented as directed arcs between nodes, with each arc indicating that one function consumes data produced by another.

In some configurations, network system 120 may optimize or improve the graph representation by simplifying data arcs when multiple functions reference identical data versions, retaining multiple arcs when functions refer to different versions of the same table, etc.

Network system 120 resolves 530 version references to determine the specific data table versions that each function will access during execution. The version resolution process handles multiple types of version references that functions may specify in their dependencies. Network system 120 resolves all references to HEAD-#(relative versions referencing historical versions) based on the latest available version at execution time T, mapping these relative references to specific absolute version identifiers. Within this schema, HEAD represents the most recent version, and HEAD-# is the # of versions removed from the most recent version.

The network system 120 creates placeholders for future versions (PLAN-#) that will be generated as part of the current execution plan, enabling functions to declare dependencies on data that will be produced by upstream functions within the same execution plan. By pre-calculating which table versions will exist when transactions complete successfully, network system 120 enables consistency checking and allows computation of new execution plans without requiring existing plans to finish execution.

Network system 120 also resolves negative relative versions (PLAN-N where N<0) by mapping them to appropriate prior versions using the formula HEAD-(N+1), ensuring that functions can reference previous table versions of tables for which the execution plan is generating a new table version.

Network system 120 constructs 540 an execution plan that specifies the precise sequence and grouping of function executions required to propagate data changes through the dependency graph. The construction process analyzes the dependency graph to determine all functions that must execute to satisfy the trigger initiated by triggering function F. Network system 120 verifies that functions are ordered according to their dependencies, allowing each function to execute only after all functions producing its input data have completed. This dependency-based ordering allows independent functions (those with no mutual dependencies) to execute in parallel, maximizing throughput while maintaining correctness.

Network system 120 may group functions into transactions based on the configured transaction strategy, which determines the atomicity boundaries for data updates (e.g., function transaction strategy, collection transaction strategy, system transaction strategy). The execution plan specifies these transaction boundaries explicitly, enabling the execution module to enforce the appropriate consistency guarantees.

Network system 120 executes 550 functions according to the execution plan, orchestrating the actual data transformations and updates across the system. The execution process begins by identifying functions with no unsatisfied data version dependencies (e.g., those whose input data tables are already available at the required versions). Network system 120 initiates execution of these ready functions, which may include the triggering function F and any other functions whose dependencies are satisfied at execution start.

Network system 120 manages 560 transactions within the execution plan, enforcing the atomicity and consistency guarantees specified by the transaction strategy. For each transaction boundary defined in the execution plan, network system 120 monitors the execution status of all functions within that transaction scope. The network system verifies that all functions within a transaction complete successfully, executing their data transformations without errors and producing valid output table versions.

In some configurations, network system 120 employs an optimistic eager execution strategy that allows functions to begin execution as soon as their input data dependencies are satisfied, even when those dependencies are produced by functions within ongoing transactions. This strategy enables the system to advance work and improve performance by executing downstream functions before upstream transactions complete. However, the visibility of updated table versions to external clients remains subject to successful transaction completion.

In some configurations, only when all functions within a transaction have completed successfully does network system 120 commit the transaction, making the updated table versions visible for general consumption by other functions and client devices. If any function within a transaction fails due to an error condition, network system 120 initiates a rollback procedure, discarding all table versions created within the failed transaction. The system also fails any dependent transactions (transactions containing functions that depend on data produced by the failed transaction) ensuring that no partial or inconsistent updates propagate through the system.

In some configurations, various additional approaches are combinations of approaches may be used when managing execution of transactions.

Network system 120 verifies 570 consistency of data table states throughout and after execution plan completion. After each transaction commits successfully, network system 120 transitions to a new consistent state where all data tables reflect the updates made by functions within the committed transaction. The system maintains a timeline of consistent states, each associated with the timestamp of the transaction that produced it.

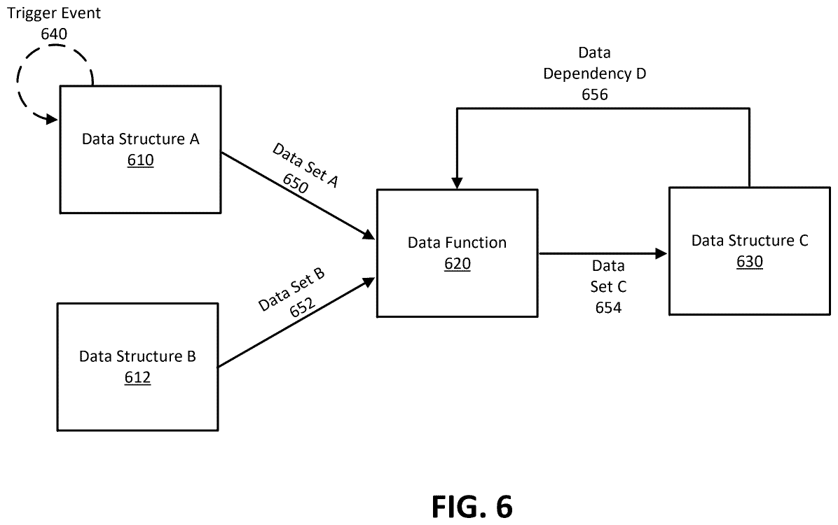

To further illustrate this process, FIGS. 6-8 demonstrates how network system 120 updates a table and verifies consistency during that update.

FIG. 6 illustrates a dependency graph for a data function, according to an example embodiment. The dependency graph represents the relationships between data structures and functions within system environment 100.

Data structure A 610 and data structure B 612 serve as input data structures for data function 620. A trigger event 640 initiates execution of data function 620. Data set A 650 connects data structure A 610 to data function 620, indicating that the function depends on data from data structure A. Data set B 652 connects data structure B 612 to data function 620, indicating that the function depends on data from data structure B. Data set D 656 connects data structure C 630 to data function 620, indicating that the function depends on prior versions of data from data structure C. Data function 620 processes the input data and produces data structure C 630 as output. Data Set C 654 represents the output relationship, connecting data function 620 to data structure C 630 to indicate that the function produces data set sec 654 for data structure C.

In this example, data sets specify which version of an input data structure a function uses during execution. When a function executes, the data set identifies the specific version of the origin table from which the function reads data. The data set may reference the most recent version of the table, a specific historical version identified by timestamp or version number, or a relative version such as HEAD~N where N indicates the number of versions prior to the current version. This versioning mechanism enables functions to operate on consistent snapshots of data, ensuring that transformations produce reproducible results even as underlying data structures evolve over time.

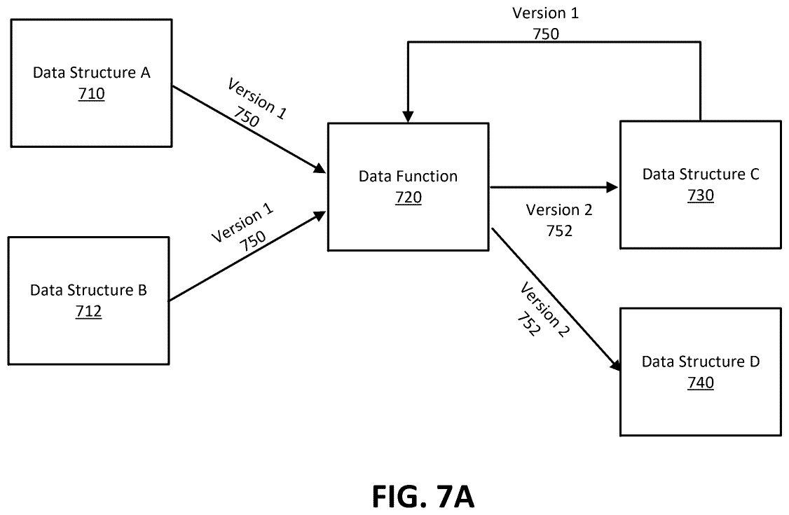

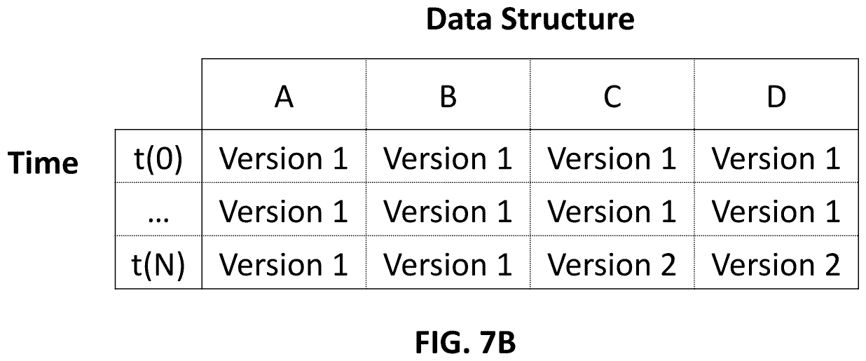

FIG. 7A illustrates version management for a single function within a transaction, according to an example embodiment. The figure demonstrates how network system 120 maintains consistent data structure states during function execution by controlling when version updates become visible to consumers.

Data structure A 710, data structure B 712, and data structure C 730, serve as input data structures providing version 1 750 data to data function 720. Data function 720 processes these inputs and generates (or modifies) data structure C 730 and data structure D 740 as outputs. The function operates within a transaction boundary that controls when the updated versions become visible to external consumers.

Throughout the execution, data function 720 processes data and generates updates to its output data structures. However, during this intermediate period, network system 120 continues to present version 1 750 of data structure C 730 and data structure D 740 to external consumers. This ensures that consumers never observe partially completed transformations or inconsistent intermediate states. The system maintains this consistent view even as the function performs its operations internally.

When all functions within the transaction complete successfully, network system 120 commits the transaction atomically, making version 2 752 of all modified data structures visible to external consumers simultaneously. This ensures that the system transitions from one pristine state to another pristine state, with no intermediate inconsistent states observable by consumers outside the transaction.

FIG. 7B illustrates a timing diagram for the function execution and version management shown in FIG. 7A, according to an example embodiment. The timing diagram demonstrates how transactional consistency is maintained across data structures when a single function executes within a transaction. At time t(0), the transaction begins execution. During this initial state, all data structures (A, B, C, and D) present version 1 to external consumers. This represents the pristine state before the transaction commences. Throughout the intermediate execution period between t(0) and t(N), function F0 executes and processes data from input structures A and B, generating updates to output structures C and D internally. However, external consumers continue to observe version 1 of structures C and D during this period. The network system 120 maintains this consistent external view while the function performs its transformations internally, ensuring that consumers never encounter partially completed work. At time t(N), function F0 completes execution successfully. With the function complete, network system 120 commits the transaction atomically. At this point, data structures C and D transition to version 2 for all consumers, while data structures A and B remain at version 1.

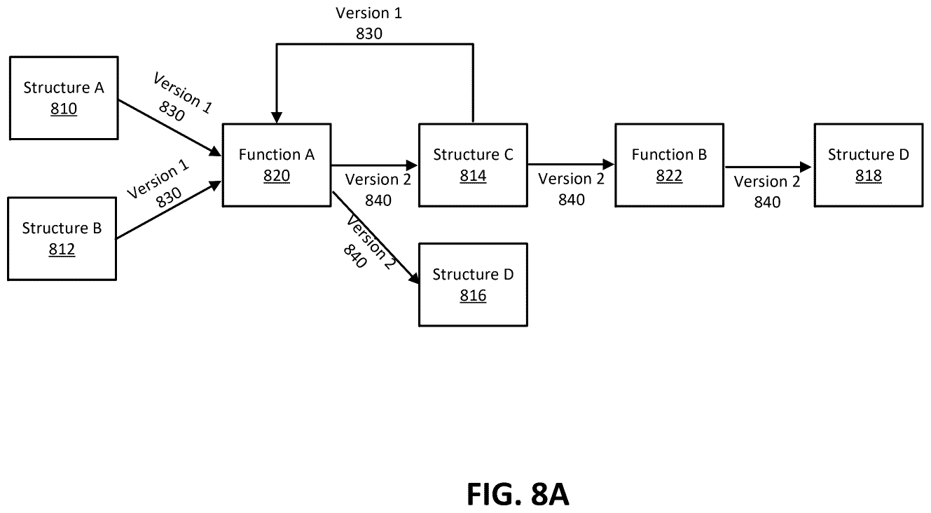

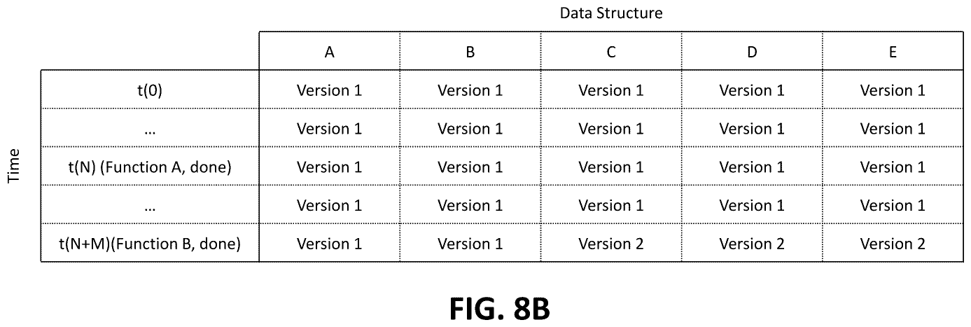

FIG. 8A illustrates version management for multiple functions within a collection transaction, according to an example embodiment. The figure demonstrates how network system 120 maintains transactional consistency when multiple functions execute within the same transaction boundary, ensuring that all data structures transition atomically to consistent states.

Structure A 810 and structure B 812 serve as input data structures providing version 1 data to function A 820. Function A 820 processes these inputs and generates (or modifies) structure C 814 and structure D 816 as outputs, both at version 2 840. Within the same transaction, function B 822 executes using structure C 814 (version 2 840) as input. Because function B 822 operates within the same transaction as function A 820, function B can access and utilize the version 2 output produced by function A, even though this version has not yet been published to external consumers. Function B 822 produces (or modifies) structure D 818 as its output, also at version 2 840.

Throughout the execution period, external consumers continue to observe version 1 830 of all data structures. The network system 120 maintains this consistent external view while allowing functions within the transaction to access intermediate results produced by other functions in the same transaction. This behavior ensures that functions can build upon each other's outputs within a transaction while preventing external consumers from observing partially completed work. When all functions within the transaction complete successfully, network system 120 commits the transaction atomically, making version 2 840 of all modified data structures visible to external consumers simultaneously. This ensures that the system transitions from one pristine state to another pristine state, with no intermediate inconsistent states observable by consumers outside the transaction.

FIG. 8B illustrates a timing diagram for the multiple function execution and version management shown in FIG. 8A, according to an example embodiment. The timing diagram demonstrates how transactional consistency is maintained across multiple data structures when multiple functions execute within a single transaction. At time t(0), the transaction begins execution. During this initial state, all data structures (A, B, C, D, and E) present version 1 to external consumers. This represents the pristine state before the transaction commences. Throughout the intermediate execution period between t(0) and t(N), function A executes and completes its processing, generating version 2 of structures C, D, and E internally. However, external consumers continue to observe version 1 of all structures during this period.

At time t(N), function A completes execution. Despite function A having finished, network system 120 does not yet commit the transaction or publish the new versions to external consumers. Instead, the system waits for all functions within the transaction to complete. During the period between t(N) and t(N+M), function B executes, utilizing version 2 of structure C produced by function A. This demonstrates the key transactional behavior: functions within the same transaction can access intermediate results produced by other functions in that transaction, even though those results remain invisible to external consumers.

At time t(N+M), function B completes execution successfully. With all functions in the transaction now complete, network system 120 commits the entire transaction atomically. At this point, structures C, D, and E transition to version 2 for all consumers, while structures A and B remain at version 1. This atomic transition ensures that the system moves from one consistent state to another, with all interdependent updates becoming visible simultaneously. The transactional consistency is maintained regardless of the number of functions and tables involved in the transaction, ensuring that consumers always observe coherent, complete states of the data.

### Provenance in Data Structures

Network system 120 also enables determination of lineage and provenance for data tables within system environment 100. By doing so, the architecture provides a robust mechanism to track the origins and transformations of every row of data.

To enable lineage and provenance determination, network system 120 assigns each row in a data table an identifier stored in the identifier column and maintains source information in the source column. The identifier ensures global uniqueness for each row, while the source column records identifiers of all source rows that contributed to the current row. In alternative embodiments, the identifier need not be explicitly stored. Instead, the physical order of the row within the data structure, combined with the collection identifier, table identifier, and data version identifier, may serve as a unique identifier for the row. Whichever approach is used, this data structuring approach enables bidirectional traceability, allowing users to investigate both upstream dependencies (the source rows from which a row was derived) and downstream usage (where the row has been utilized in subsequent transformations).

Provenance is automatically propagated through structured transformations, such as projections, filters, joins, and aggregations, ensuring that the lineage of data remains intact. Network system 120 handles these transformations such that detailed traceability is balanced against system performance.

For projection and filtering operations, network system 120 maintains provenance by preserving the source column information from input rows. When a projection function selects a subset of columns or a filter function selects a subset of rows, each resulting row retains the identifiers from the source column of the corresponding input row, ensuring that the lineage remains intact through these operations.

For join operations, network system 120 aggregates provenance from all contributing rows. When a join function combines data from multiple input data structures, the resulting rows contain source columns populated with identifiers from all rows across the input data structures that contributed to each output row, maintaining complete traceability across the join operation.

For scalar aggregation operations, network system 120 avoids unnecessary overhead by using aggregation identifiers to represent collective provenance. When an aggregation function computes aggregate values from multiple rows, the system generates a single aggregation identifier representing all input rows that contributed to the aggregation, preventing exponential growth in provenance size while maintaining traceability to the aggregated data set.

Further, network system 120 provides intuitive tools for users to trace data provenance and understand dependencies. The framework enables full transparency and accountability, ensuring that users can reliably track data origins and transformations. This functionality is critical for maintaining data integrity, compliance, and reproducibility in enterprise-grade workflows.

As an example of provenance tracking in operation, consider a manufacturing quality control system where a user needs to understand the origin of a defect rate metric for a production batch. The user queries the network system 120 to determine upstream provenance for a specific defect rate value in a quality summary table. The network system 120 accesses the source column of the row containing the defect rate, retrieves the identifiers stored therein, and traces these identifiers back through intermediate inspection tables to the original sensor measurement tables where the underlying quality control data was first ingested. The network system 120 may generate a visualization displaying the complete data lineage, showing how the defect rate was derived from aggregated inspection results, which were themselves computed from individual sensor readings imported from production line monitoring systems.

Conversely, when a user needs to assess the downstream impact of correcting an error in a source sensor reading, the user queries the network system 120 for downstream provenance. The network system 120 identifies all tables and rows that reference the corrected record's identifier in their source columns, recursively following these references through the dependency chain to identify all derived calculations, reports, and analytics that depend on the corrected data. The network system 120 may generate a visualization illustrating the propagation of the correction through aggregated quality metrics tables, defect analysis tables, and ultimately to production management dashboard displays, enabling the user to understand the full scope of data affected by the correction.

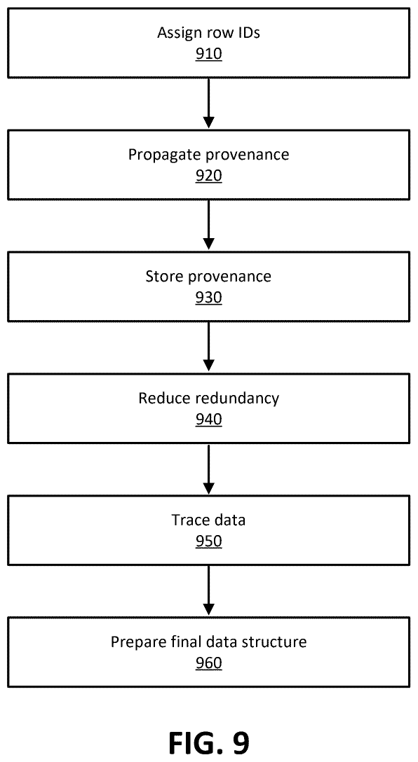

FIG. 9 illustrates a workflow of network system 120 tracking lineage and provenance for data tables, according to an example embodiment. The workflow may include additional or fewer elements, elements may occur in a different order, or elements may be repeated, depending on the configuration of system environment 100.

Network system 120 assigns 910 identifiers to each row in data structures within the system. The assignment process establishes unique identifiers that enable tracking of data lineage across transformations. The assigned identifiers are used to track back to components used to generate elements in the row (e.g., a collection identifier, a function identifier, a version identifier, a table name, a record index, etc.).

Network system 120 propagates 920 provenance information through data transformations. The propagation process maintains lineage information as data flows through functions, enabling each output row to retain references to the input rows that contributed to its creation. The specific propagation mechanism varies depending on the type of transformation being performed (as described above).

Network system 120 stores 930 provenance information within the data structures themselves. The storage process embeds provenance data directly into each data structure, eliminating the need for separate provenance tracking systems. Network system 120 adds additional information associated with each table stored in the system. This information may be maintained in the form of system-managed columns in each table. For example, a first system column stores the row identifier (e.g., an identifier column) and a second system column stores the provenance identifiers (e.g., a source column). In some configurations, the provenance information includes a deduplicated list of provenance identifiers indicating the row's lineage. Before network system 120 executes functions, the provenance information of input tables is preprocessed to maintain lineage integrity. The preprocessing converts the identifier column into a single-element list in the source column to enable seamless propagation through subsequent transformations.

Network system 120 reduces 940 redundancy in stored provenance information. The redundancy reduction process optimizes storage requirements while preserving complete lineage information. For example, network system 120 may deduplicate provenance data to minimize redundancy and storage requirements. When a source column in a single row references the same source row several times, the system eliminates duplicate identifiers from the source columns. In some cases, bit-masking is used to encode source and/or identifier information into the provenance identifiers, allowing for a compact representation. The bit-masking approach allows the system to represent complex aggregation provenance using the same storage space as individual row references.

Network system 120 traces 950 data lineage in response to user queries. The tracing process enables users to understand data origins and impacts by traversing the provenance information stored in data structures. For upstream data tracing, in an example, users can query the source column to identify the source rows from which a given row was derived. The dependency information within each provenance identifier helps locate the dataset version and table where the source row resides. The system recursively follows source column references across multiple data structures to construct complete upstream lineage paths. For downstream data tracing, in an example, the system tracks how a row is used in subsequent datasets by identifying all rows in other data structures whose source columns reference the row's identifier. This enables users to trace the downstream impact of changes or updates, understanding which derived data structures and analytics would be affected by modifications to source data.

Network system 120 prepares 960 the final data structure for storage and consumption. The preparation process generates and stores provenance information in a manner such that it is ready for efficient querying. After processing by network system 120, each resulting table includes a refreshed identifier column for new rows, with each row receiving a unique identifier reflecting its position in the current data structure version. The final data structure, with its embedded provenance information, can be queried by client devices to retrieve data elements and their lineage, subscribed to by receiver client devices to receive updates when the data structure changes, or exported to external data sources for consumption by downstream systems.

Using this methodology, network system 120 preserves lineage and provenance across all transformations, offering fine-grained traceability while maintaining efficient system performance. By combining robust ID generation, optimized provenance propagation, and user-friendly tracing tools, network system 120 delivers a powerful framework for managing data lineage and provenance at scale.

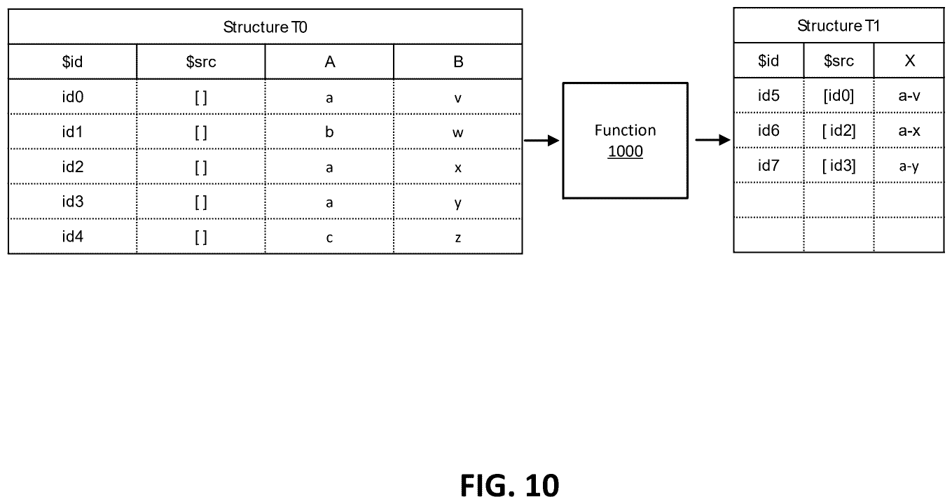

FIG. 10 illustrates provenance tracking for projection and filtering operations, according to an example embodiment. The figure demonstrates how network system 120 maintains provenance information when a function performs projection and filtering transformations on an input data structure.

Structure T0 serves as the input data structure for function 1000. Structure T0 includes multiple rows, each containing an identifier in the identifier column ($id). It also contains provenance information in the source column ($src), initially populated with empty lists there is no upstream dependency for these tables. Structure T0 also includes data columns A and B. For example, row id0 contains value “a” in column A and value “v” in column B, while row id1 contains value “b” in column A and value “w” in column B.

Function 1000 performs both filtering and projection operations on structure T0. In an example the function 100 may be:
select A+‘-’+B as X
into T1
From T0
Where A=‘a’

The function 1000 filters rows where column A equals “a”, selecting only those rows that satisfy this condition. The function then projects a new column X by concatenating values from columns A and B with a hyphen separator. The function outputs the results to structure T1.

Structure T1 contains the results of function 1000. Each row in structure T1 includes an identifier in the identifier column ($id), and a source column ($src) containing provenance information. Additionally, T1 includes the projected column X. For rows that pass the filter condition, the source column contains the identifier of the corresponding row information from structure T0.

The source column in Structure T1 maintains provenance information for the data therein. For each row, the provenance information includes an identifier for the rows from which the data in that row originated. For example, for the row having the ID “id7”, the provenance information reads “id3”. This means that the information in the row “id7” came from the row “id3” in T0.

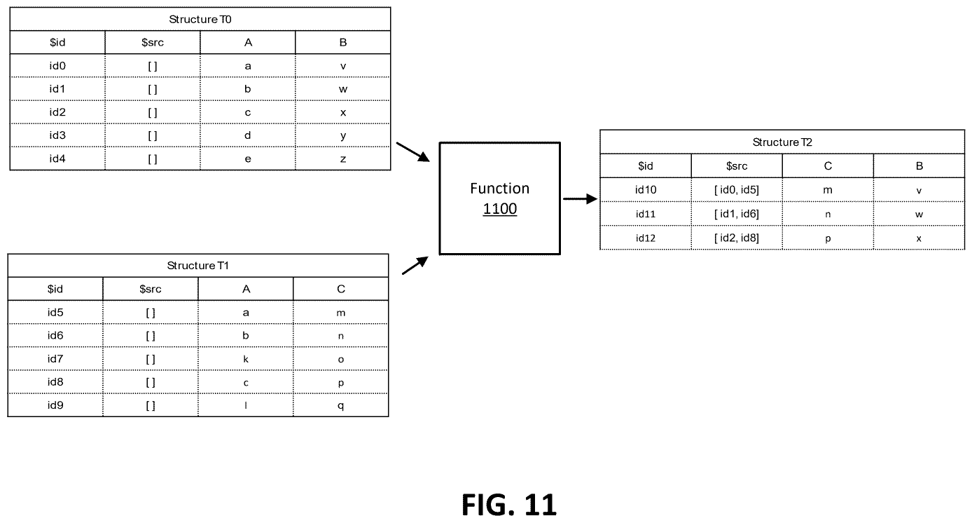

FIG. 11 illustrates provenance tracking for join operations, according to an example embodiment. The figure demonstrates how network system 120 maintains provenance information when a function performs join transformations on input data structures.

Structure T0 and structure T1 serve as input data structures for function 1100. Structure T0 includes multiple rows, each containing an identifier in the identifier column ($id), provenance information in the source column ($src). Structure T0 includes data columns A and B, and structure T1 includes data columns A and C.

For example, in structure T1, row id0 contains value “a” in column A and value “v” in column B, while row id1 contains value “b” in column A and value “w” in column B. In Structure T1, row id5 contains value “a” in column A and value “m” in column C. In both structures the source column is empty because they do not depend on any upstream information.

Function 1100 performs a join operation on structure T0 and structure T1. In an example, the function 1100 may be:
select T1.C, T0.B
into T2
from T0
inner join T1

### On T0.a=T1.a

Structure T2 contains the results of function 1100. The function 1100 joins rows from structure T0 and structure T1 where the values in column A match. For each matched pair of rows, the function selects column C from structure T1 and column B from structure T0. Each row in structure T2 includes an identifier in the identifier column ($id) information, a source column ($src) and the selected data columns C and B.

The source column in structure T2 maintains provenance information for the joined data. For each row, the provenance information includes identifiers for all rows from the input structures that contributed to that row. For example, for a row having the identifier “id10”, the provenance information may read “[id0, id5]”. This means that the information in row “id10” came from row “id0” in structure T0 and row “id5” in structure T1. This aggregation of provenance identifiers from multiple input structures enables complete traceability of data origins through join operations.

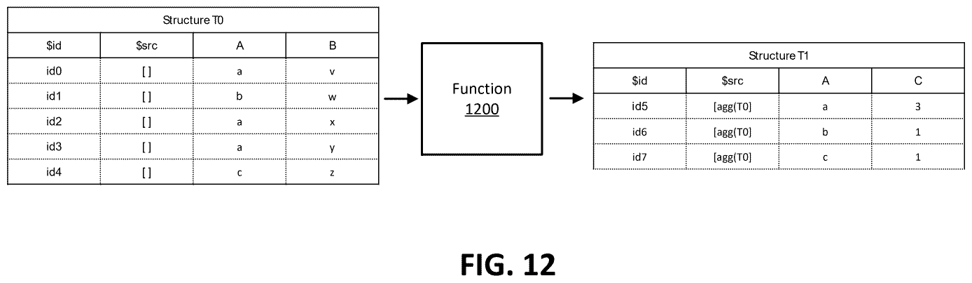

FIG. 12 illustrates provenance tracking for aggregation operations, according to an example embodiment. The figure demonstrates how network system 120 maintains provenance information when a function performs aggregation transformations on an input data structure while avoiding exponential growth in provenance size.

Structure T0 serves as the input data structure for function 1200. Structure T0 includes multiple rows, each containing an identifier in the identifier column ($id), provenance information in the source column ($src), and data columns A and B. For example, row id0 contains value “a” in column A and value “v” in column B, row id1 contains value “b” in column A and value “w” in column B, row id2 contains value “a” in column A and value “x” in column B, row id3 contains value “a” in column A and value “y” in column B, and row id4 contains value “c” in column A and value “z” in column B. The source column is initially empty because these rows do not depend on any upstream information.

Function 1200 performs an aggregation operation on structure T0. In an example, the function 1200 may be:
select A, count(*) as C
into T1
from T0
group by A

Structure T1 contains the results of function 1200. The function 1200 groups rows from structure T0 by the values in column A and computes a count of rows within each group. For each distinct value in column A, the function generates a row in structure T1 containing the grouping value and the count. Each row in structure T1 includes an identifier in the identifier column ($id), grouping column A, and the aggregated result column C.

The source column ($src) in structure T1 maintains provenance information for the aggregated data using a special aggregation identifier. Rather than storing individual identifiers for every row that contributed to the aggregation (which could result in exponential growth in provenance size), the network system 120 generates an aggregation identifier that represents the collective provenance of all input rows. For example, for a row having the identifier “id5”, the provenance information may read “[agg(T0)]”, indicating that this row was derived from an aggregation operation performed on structure T0. This aggregation identifier encodes information about the aggregation function type and the source data structure, enabling traceability to the aggregated dataset while maintaining compact storage requirements. The same aggregation identifier approach applies to rows id6 and id7, each representing aggregated counts for their respective grouping values in column A.

### Scalability and Resilience

Network system 120 is designed to integrate with distributed execution frameworks to deliver scalability and resilience for the table-based data provisioning operations described herein. The system architecture enables deployment on orchestration platforms and other distributed computing infrastructures, leveraging the capabilities these frameworks provide for resource management, fault tolerance, and elastic scaling. The network system 120 implements its data provisioning, provenance tracking, and transactional consistency mechanisms within this distributed execution environment, ensuring that the novel table-based architecture operates reliably at scale.

The network system 120 configures its components for deployment within distributed execution frameworks through configuration specifications that define resource requirements, health monitoring parameters, and scaling policies for each component. These configurations enable the distributed execution framework to manage the lifecycle of system components, including the authentication server, control server, catalog server, data server, and function workers described above. The configuration approach allows network system 120 to leverage the deployment automation, service discovery, and load balancing capabilities provided by the underlying distributed execution framework.

When deployed on a distributed execution framework, network system 120 utilizes the framework's resource scaling mechanisms to adjust computational capacity based on workload demands. The distributed execution framework monitors resource utilization metrics and provisions additional computational nodes during periods of high activity, enabling the system to handle increased volumes of data provisioning requests, function executions, and provenance queries. During periods of lower activity, the framework deallocates underutilized resources, optimizing operational costs. The framework's self-healing capabilities automatically restart failed components and replace unhealthy nodes, ensuring continuity of the data provisioning operations.

Network system 120 implements an event-driven execution model for managing data provisioning workflows within the distributed execution environment. The system generates and processes events that drive function execution, dependency resolution, and data propagation. Request events are initiated by, e.g., external API calls from client devices requesting data provisioning operations. Cascade events are generated when function execution triggers dependent downstream functions according to the dependency graphs described above. Trigger events are produced by changes to data sources or data tables, initiating execution plans that propagate updates through the system.

The network system 120 manages event queues and dispatches function execution tasks to worker nodes within the distributed execution framework. Each function execution task operates on the data structures with embedded identifier and source columns, performing the transformations while maintaining provenance information as described above. The distributed execution framework schedules these tasks across available computational nodes, enabling parallel execution of independent functions while respecting the dependency ordering specified in execution plans. This architecture ensures that the novel provenance tracking and transactional consistency mechanisms operate correctly even as function executions are distributed across multiple nodes.

The network system 120 deploys its functional components as services within the distributed execution framework. The authentication server manages authentication and token distribution for client devices accessing the system. The control server processes API requests from client devices and coordinates system operations. The catalog server maintains metadata about data structures, functions, and dependencies as a persistent service. The data server coordinates execution of functions and manages the data structures with their embedded provenance information. Function workers execute as short-lived computational tasks that perform the data transformations, provenance propagation, and transaction management operations described above. The distributed execution framework manages concurrency control, isolates failures to individual function executions, and restarts failed tasks to ensure completion of execution plans.

The network system 120 leverages fault recovery mechanisms provided by the distributed execution framework to enhance resilience of data provisioning operations. When a function worker fails during execution, the distributed execution framework automatically restarts the task on an available node, enabling the execution plan to complete despite transient failures. The system implements retry logic with exponential backoff for tasks that fail due to temporary resource constraints or network issues. The distributed execution framework's dynamic resource scaling prevents resource contention by provisioning additional capacity when utilization thresholds are exceeded, maintaining performance of data provisioning operations under varying load conditions.

By deploying within distributed execution frameworks, network system 120 achieves scalability and resilience for its table-based data provisioning architecture. The system leverages the resource management, fault tolerance, and elastic scaling capabilities provided by these frameworks while implementing the novel mechanisms for provenance tracking, transactional consistency, and dependency-driven execution described herein. This integration enables the network system 120 to maintain the correctness guarantees of its data provisioning operations across distributed, large-scale deployments.

### IV. Example Systems And Workflows

### First Example

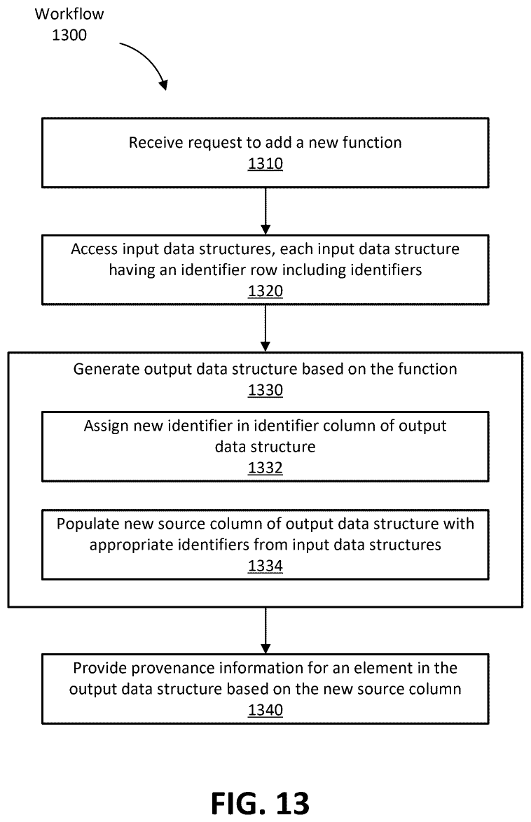

FIG. 13 is a workflow diagram for generating an output data structure with provenance tracking, according to an example embodiment. In various configurations, the workflow 1300 may include additional or fewer elements, and the elements may occur in a different order. Moreover, one or more of the elements in the workflow 1300, or the workflow 1300 itself, may be repeated.

At 1310, the network system 120 receives a request to add a new function. The request specifies the function definition, including input data structures, output data structures, and the transformation logic to be applied. The request may originate from a client device 110 or may be generated programmatically by another component within the system environment 100.

At 1320, the network system 120 accesses input data structures for the function. Each input data structure comprises rows with an identifier column containing unique identifiers for each row. Each input data structure may also include a source column storing provenance information. The network system 120 retrieves the input data structures from storage 350 and prepares them for processing by the function.

At 1330, the network system 120 generates an output data structure based on the function.

At 1332, the network system 120 assigns a new identifier to each row in the output data structure. The new identifier is stored in the identifier column of the output data structure. The identifier uniquely identifies each row and may include information such as collection identifier, function identifier, table identifier, partition identifier, table version identifier, table name, record index, etc.

At 1334, the network system 120 populates a new source column of the output data structure with appropriate identifiers from the input data structures. For each row in the output data structure, the network system 120 identifies which rows from the input data structures contributed to or modified data elements in that output row. The network system 120 stores the identifiers of these contributing input rows in the source column of the output row, establishing provenance links between the output data and its source data.

At 1340, the network system 120 provides provenance information for an element in the output data structure based on the new source column. When a user or system component requests provenance information for a specific data element, the network system 120 accesses the source column of the row containing that element. The network system 120 retrieves the identifiers stored in the source column and uses these identifiers to trace back to the input data structures and rows that contributed to the element, enabling complete upstream provenance tracking.

### Second Example

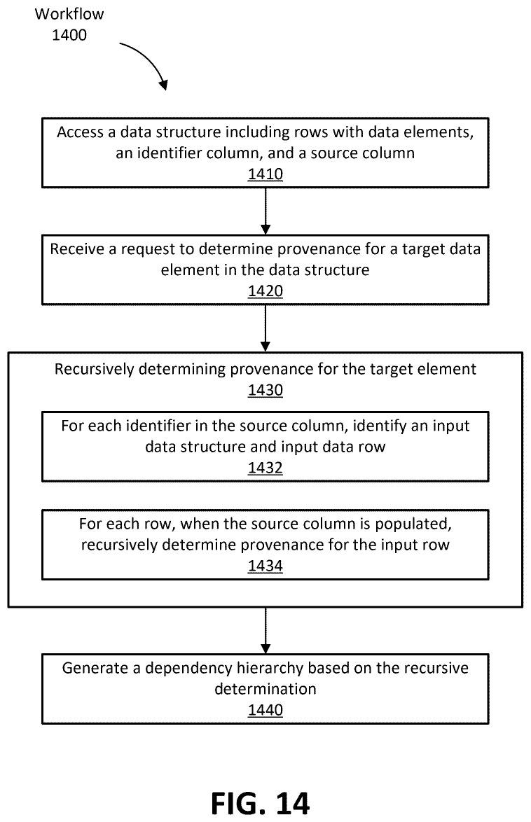

FIG. 14 is a workflow diagram for determining provenance for a data element in a data structure, according to an example embodiment. In various configurations, the workflow 1400 may include additional or fewer elements, and the elements may occur in a different order. Moreover, one or more of the elements in the workflow 1400, or the workflow 1400 itself, may be repeated.

At 1410, the network system 120 accesses a data structure comprising a plurality of rows. Each row comprises one or more data elements, an identifier column storing an identifier for the row, and a source column storing identifiers of rows from one or more input data structures that contributed to data elements in the row. The identifier uniquely identifies each row and may include information such as collection identifier, function identifier, table identifier, partition identifier, table version identifier, table name, record index, etc. The source column maintains provenance information linking data elements in the current row to their origins in input data structures.

At 1420, the network system 120 receives a request to determine provenance for a target data element in a target row of the data structure. The request may originate from a client device 110 or may be generated programmatically by another component within the system environment 100. The request identifies the specific data element for which provenance information is sought.

At 1430, the network system 120 recursively determines provenance for the target data element. The recursive determination process traces the lineage of the target data element back through the chain of transformations that produced it.

At 1432, the network system 120 accesses identifiers from the source column of the target row. For each identifier in the source column, the network system 120 identifies a corresponding input data structure and a corresponding input row within that input data structure based on the identifier. The identifier contains information that enables the network system 120 to locate the specific data structure and row that contributed to the target data element.

At 1434, for each corresponding input row identified, when the source column of that input row is populated, the network system 120 recursively determines provenance for the input row. This recursive process continues, following the chain of source column references backward through successive data structures until reaching rows whose source columns are empty, indicating original source data with no upstream dependencies. When an identifier represents an aggregation identifier, the network system 120 identifies the corresponding input data structure without matching a specific record index, recognizing that the aggregation represents collective provenance from multiple rows.

At 1440, the network system 120 generates a dependency hierarchy for the target data element based on the source rows identified through the recursive determination. The dependency hierarchy represents the complete lineage of the target data element, showing all input data structures and rows that contributed to its value through the chain of transformations. The network system 120 provides this dependency hierarchy in response to the request for provenance information, enabling users to understand the origins and transformations that produced the target data element.

### Third Example

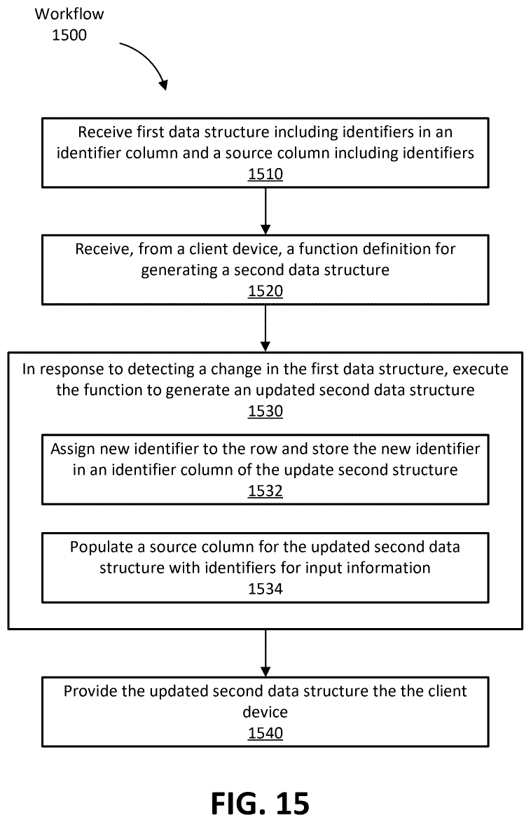

FIG. 15 is a workflow diagram for provisioning data in a publish-subscribe data provisioning system with provenance tracking, according to an example embodiment. In various configurations, the workflow 1500 may include additional or fewer elements, and the elements may occur in a different order. Moreover, one or more of the elements in the workflow 1500, or the workflow 1500 itself, may be repeated.

At 1510, the publish-subscribe data provisioning system receives a first data structure including identifiers in an identifier column and a source column including identifiers. The first data structure is received from a publisher client device that generates data for publication within the system environment 100. Each row in the first data structure includes an identifier stored in the identifier column that uniquely identifies the row. Each row also includes a source column storing identifiers of rows from one or more input data structures that contributed to data elements in the row. The source column maintains provenance information linking data elements in the current row to their origins in upstream data structures.

At 1520, the publish-subscribe data provisioning system receives, from a subscriber client device, a function definition for generating a second data structure. The function definition specifies the transformation logic to be applied, the input data structures on which the function depends, and the output data structures that the function will generate. The function definition establishes a dependency relationship where the second data structure depends on the first data structure, such that changes to the first data structure trigger updates to the second data structure.

At 1530, in response to detecting a change in the first data structure, the publish-subscribe data provisioning system executes the function to generate an updated second data structure. The execution process applies the transformation logic defined by the function to data from the first data structure, producing new or modified rows in the second data structure.

At 1532, the publish-subscribe data provisioning system assigns a new identifier to each row in the updated second data structure and stores the new identifier in an identifier column of the updated second data structure. This identifier enables the system to track each row across subsequent transformations and updates within the system environment 100.

At 1534, the publish-subscribe data provisioning system populates a source column for the updated second data structure with identifiers for input information. For each row in the updated second data structure, the system identifies which rows from the first data structure contributed to or modified data elements in that row. The system stores the identifiers of these contributing rows from the first data structure in the source column of the corresponding row in the updated second data structure. This establishes provenance links between the updated second data structure and its source data in the first data structure, enabling bidirectional traceability of data origins and transformations.

At 1540, the publish-subscribe data provisioning system provides the updated second data structure to the subscriber client device. The subscriber client device receives the updated data structure through the subscription mechanism, enabling the subscriber to access the transformed data with complete provenance information embedded in the identifier and source columns. The subscriber client device may use this data for further processing, analysis, or provisioning to external data sources.

### Fourth Example

FIG. 16 is a workflow diagram for maintaining data consistency through pristine state transitions in a data provisioning network system, according to an example embodiment. In various configurations, the workflow 1600 may include additional or fewer elements, and the elements may occur in a different order. Moreover, one or more of the elements in the workflow 1600, or the workflow 1600 itself, may be repeated.

At 1610, the network system 120 establishes an initial pristine state for data structures within the system environment 100. The initial pristine state represents a consistent state of all data structures before execution of any functions commences. Each data structure in the initial pristine state includes rows with identifier columns and source columns maintaining complete provenance information. The network system 120 may verify that all data structures reflect internally consistent logic and data relationships, with no partial updates or inconsistent intermediate states visible to consumers.

At 1620, the network system 120 identifies a trigger event for a triggering function. The trigger event initiates execution of the triggering function, which serves as the root of the dependency graph for the execution plan. Trigger events may comprise changes to data sources, changes to data tables, user commands, time-based schedules, condition-based events, or external system notifications. The network system 120 captures the trigger event and associates it with the corresponding triggering function that will begin the execution workflow.

At 1630, the network system 120 constructs a dependency graph based on the triggering function. The dependency graph represents the complete set of functions and data dependencies involved in propagating changes through the system.

At 1632, the network system 120 adds the trigger event to the dependency graph. The triggering function associated with the trigger event becomes the root node of the dependency graph, establishing the starting point for dependency resolution and execution sequencing.

At 1634, the network system 120 identifies additional functions related to the trigger event. The network system 120 examines the triggering function to determine which downstream functions are connected through trigger relationships or data dependencies. Functions may be connected through trigger relationships when execution of one function initiates execution of another function. Functions may be connected through data dependencies when one function consumes data produced by another function. The network system 120 recursively identifies all functions transitively connected to the triggering function through these relationships, and may do so using internal provenance information.

At 1636, the network system 120 adds the identified additional functions to the dependency graph. Each identified function becomes a node in the dependency graph, with directed arcs representing trigger relationships and data dependencies between functions. As noted above, the network system 120 constructs the complete dependency graph by recursively adding all transitively connected functions such that the graph captures all functions that must execute to propagate the triggered change through the system.

At 1640, the network system 120 generates an execution plan based on the dependency graph. The execution plan specifies the precise sequence and grouping of function executions required to propagate data changes while maintaining consistency.

At 1642, the network system 120 determines an ordered sequence of functions to execute based on the dependency graph. The network system 120 analyzes the dependency relationships to establish an execution order where each function executes only after all functions producing its input data have completed. This dependency-based ordering ensures correctness while allowing independent functions with no mutual dependencies to execute in parallel.

At 1644, the network system 120 groups functions into transactions based on a transaction strategy. The transaction strategy determines the atomicity boundaries for data updates. The execution plan specifies these transaction boundaries explicitly, enabling enforcement of appropriate consistency guarantees.

At 1650, the network system 120 executes the functions according to the execution plan. The network system 120 identifies functions with no unsatisfied data dependencies and initiates execution of these ready functions. As each function completes, the network system 120 marks its output data structure versions as available, enabling downstream functions whose dependencies are now satisfied to begin execution. The network system 120 orchestrates parallel execution of independent functions while respecting the dependency ordering specified in the execution plan.

At 1660, the network system 120 commits each transaction only when all its functions complete successfully. For each transaction boundary defined in the execution plan, the network system 120 monitors execution status of all functions within that transaction scope. The network system 120 verifies that all functions within the transaction have completed successfully, executing their data transformations without errors and producing valid output data structure versions. Only when all functions within a transaction have completed successfully does the network system 120 commit the transaction, making the updated data structure versions visible for consumption by other functions and client devices. If any function within a transaction fails, the network system 120 rolls back all data structure versions created within the failed transaction and fails any dependent transactions, ensuring that no partial or inconsistent updates propagate through the system.

At 1670, the network system 120 transitions to an updated pristine state after all transactions in the execution plan complete successfully. The updated pristine state represents a new consistent state of all data structures, where all interdependent updates have been applied atomically and are visible to consumers. The network system 120 enables the system to move seamlessly from the initial pristine state to the updated pristine state, with no intermediate inconsistent states observable by external consumers. The updated pristine state becomes the new baseline for subsequent execution plans, maintaining the continuous evolution of data structures through consistent state transitions.

### V. Control System

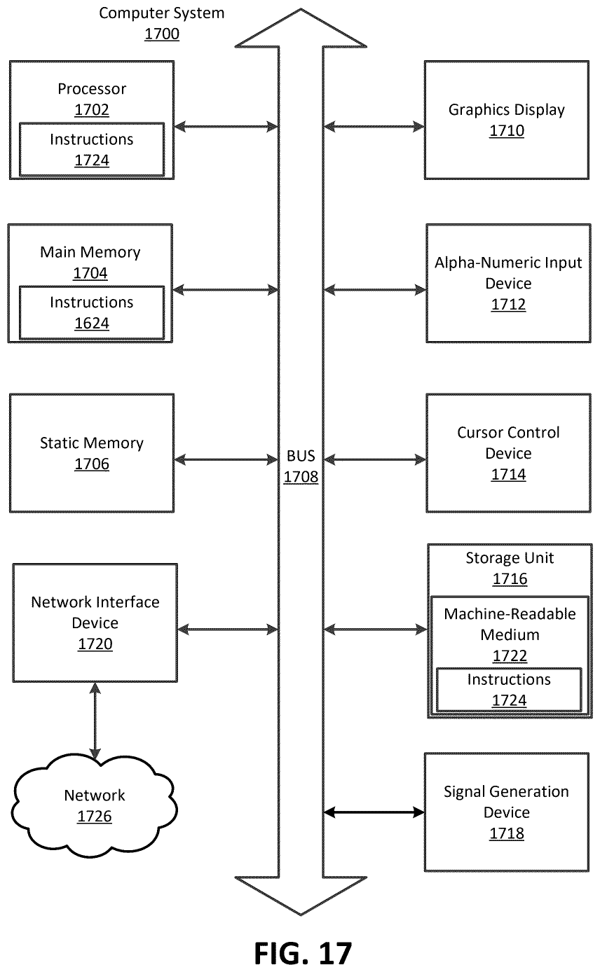

FIG. 17 is a block diagram illustrating components of an example machine for reading and executing instructions from a machine-readable medium. Specifically, FIG. 17 shows a diagrammatic representation of a control elements in the example form of a computer system 1700. The computer system 1700 may be used to execute instructions 1724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet computer, a smartphone, an Internet of Things (IoT) appliance, a network router, switch or bridge, or any machine capable of executing instructions 1724 (sequential or otherwise) that specify actions to be taken by that machine. Further, while only a single machine is illustrated, the term “machine” shall also be taken to include any collection of machines that individually or jointly execute instructions 1724 to perform any one or more of the methodologies discussed herein.

The example computer system 1700 includes a processing system having one or more processing units (generally processor 1702). The processor 1702 is, for example, a central processing unit (CPU), a graphics processing unit (GPU), a digital signal processor (DSP), a tensor processor, an optical processor, a neural network processor, a controller, a state machine, one or more application-specific integrated circuits (ASICs), one or more radio-frequency integrated circuits (RFICs), or any combination of these. The computer system 1700 also includes a main memory 1704 (e.g., dynamic random access memory (DRAM) and/or static random access memory (SRAM)). The computer system may include a storage unit 1716. The processor 1702, memory 1704, and the storage unit 1716 communicate via a bus 1708.

In addition, the computer system 1700 may include a static memory 1706, a graphics display 1710 (e.g., to drive a plasma display panel (PDP), a liquid crystal display (LCD), or a projector). The computer system 1700 may also include an alphanumeric input device 1712 (e.g., a keyboard), a cursor control device 1714 (e.g., a mouse, a trackball, a joystick, a motion sensor, or other pointing instrument), a signal generation device 1718 (e.g., a speaker), and a network interface device 1720, which also are configured to communicate via the bus 1708.

The storage unit 1716 includes a machine-readable medium 1722 on which is stored instructions 1724 (e.g., software) embodying any one or more of the methodologies or functions described herein. For example, the instructions 1724 may include the functionalities of modules of the system. The instructions 1724 may also reside, completely or at least partially, within the main memory 1704 or within the processor 1702 (e.g., within a processor's cache memory) during execution thereof by the computer system 1700, the main memory 1704 and the processor 1702 also constituting machine-readable media. The instructions 1724 may be transmitted or received over a network 1726 via the network interface device 1720.

### V. Additional Considerations

In the description above, for purposes of explanation, numerous specific details are set forth in order to provide a thorough understanding of the illustrated system and its operations. It will be apparent, however, to one skilled in the art that the system may be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B is true (or present).

In addition, the use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for implementing the functionality described herein. Thus, while particular embodiments and applications have been illustrated and described, it is to be understood that the disclosed embodiments are not limited to the precise construction and components disclosed herein. Various modifications, changes, and variations, which will be apparent to those, skilled in the art, may be made in the arrangement, operation, and details of the method and apparatus disclosed herein without departing from the spirit and scope defined in the appended claims.

A publish-subscribe data provisioning system employs a generator-receiver model for tables where network systems generate data from source systems and client devices receive these tables. Each data structure comprises rows with an identifier column storing a unique identifier for each row and a source column containing identifiers of records from other tables used to create the current record. Functions control how data is translated between tables and client devices, including generator functions mapping data from sources to tables, receiver functions mapping tables to data sources, and transformation functions mapping between tables. Dependency graphs define relationships between tables, enabling execution plans that propagate changes through the system. The architecture supports complete lineage tracking and record-level provenance, enabling bidirectional traceability of data origins and transformations across the system.

What is claimed is:

1. A method for maintaining data consistency in a data provisioning network system, the method comprising:
establishing an initial pristine state for a plurality of data structures within the data provisioning network system, wherein the initial pristine state represents a consistent state of the plurality of data structures;
identifying a trigger event associated with a triggering function;
constructing a dependency graph based on the triggering function, wherein constructing the dependency graph comprises:
adding the triggering function to the dependency graph,
recursively identifying additional functions connected to the triggering function through hierarchical relationships or data dependencies, and
adding the identified additional function to the dependency graph;
generating an execution plan based on the dependency graph, wherein generating the execution plan comprises:
determining an ordered sequence of functions to execute based on the dependency graph; and
grouping the functions into one or more transactions based on a transaction strategy;
executing the functions according to the execution plan within the one or more transactions;
committing each transaction of the one or more transactions only when all functions within that transaction complete successfully; and
transitioning to an updated pristine state for the plurality of data structures after all transactions in the execution plan complete successfully, wherein the updated pristine state represents a new consistent state of the plurality of data structures.

2. The method of claim 1, wherein constructing the dependency graph comprises:
accessing identifier columns and source columns of data structures associated with functions in the dependency graph;
tracing identifiers stored in the source columns to determine upstream and downstream data structures that contributed to each data structure; and
recursively following the identifiers in the source columns across multiple data structures to map data dependencies from original source data through intermediate transformations to output data structures.

3. The method of claim 2, wherein tracing identifiers stored in the source columns comprises:
for each identifier in a source column of a data structure, extracting information identifying a collection identifier, a function identifier, a table identifier, and a record index; and
using the extracted information to locate a corresponding row in an upstream data structure that contributed to the data structure.

4. The method of claim 1, wherein constructing the dependency graph comprises:
constructing a trigger graph by adding the triggering function to the trigger graph and recursively adding functions that are transitively triggered by the triggering function; and
constructing a data dependency graph by adding functions having data dependencies on functions in the trigger graph.

5. The method of claim 1, wherein constructing the dependency graph comprises:
identifying data version information for each data structure associated with functions in the dependency graph; and
using the data version information to determine which specific versions of data structures each function depends upon.

6. The method of claim 5, wherein generating the execution plan comprises:
resolving relative version references to specific data structure versions based on a latest available version at an execution time; and
creating placeholders for future data structure versions that will be generated during execution of the execution plan.

7. The method of claim 1, wherein committing each transaction comprises:
verifying that all functions within the transaction have completed successfully;
making updated data structure versions visible for consumption only after verifying successful completion of all functions within the transaction; and
maintaining visibility of previous data structure versions to external consumers until the transaction commits successfully.

8. The method of claim 1, further comprising:
detecting a failure of a function within a transaction;
rolling back all data structure versions created within the failed transaction; and
failing all dependent transactions that contain functions depending on data structures produced by the failed transaction.

9. The method of claim 1, wherein the transaction strategy comprises one of:
a function transaction strategy wherein each function executes in its own transaction;
a collection transaction strategy wherein functions operating on data structures within a single collection execute within a shared transaction; and
a system transaction strategy wherein all functions across all collections execute within a single transaction.

10. The method of claim 1, wherein executing the functions according to the execution plan comprises:
initiating execution of a downstream function when input data dependencies for the downstream function are satisfied by data structures produced by upstream functions within ongoing transactions;
allowing the downstream function to access data structures produced by the upstream functions before the ongoing transactions commit; and
maintaining visibility of updated data structure versions to external consumers subject to successful completion of the ongoing transactions.

11. A non-transitory computer-readable storage medium comprising computer program instructions for maintaining data consistency in a data provisioning network system, the computer program instructions, when executed by one or more processors, causing the one or more processors to:
establish an initial pristine state for a plurality of data structures within the data provisioning network system, wherein the initial pristine state represents a consistent state of the plurality of data structures;
identify a trigger event associated with a triggering function;
construct a dependency graph based on the triggering function, wherein constructing the dependency graph comprises:
adding the triggering function to the dependency graph,
recursively identifying additional functions connected to the triggering function through hierarchical relationships or data dependencies, and
adding the identified additional function to the dependency graph;
generate an execution plan based on the dependency graph, wherein generating the execution plan comprises:
determining an ordered sequence of functions to execute based on the dependency graph; and
grouping the functions into one or more transactions based on a transaction strategy;
execute the functions according to the execution plan within the one or more transactions;
commit each transaction of the one or more transactions only when all functions within that transaction complete successfully; and
transition to an updated pristine state for the plurality of data structures after all transactions in the execution plan complete successfully, wherein the updated pristine state represents a new consistent state of the plurality of data structures.

12. The non-transitory computer-readable storage medium of claim 11, wherein constructing the dependency graph causes the one or more processors to:
access identifier columns and source columns of data structures associated with functions in the dependency graph;
trace identifiers stored in the source columns to determine upstream and downstream data structures that contributed to each data structure; and
recursively follow the identifiers in the source columns across multiple data structures to map data dependencies from original source data through intermediate transformations to output data structures.

13. The non-transitory computer-readable storage medium of claim 12, wherein tracing identifiers stored in the source columns causes the one or more processors to:
for each identifier in a source column of a data structure, extract information identifying a collection identifier, a function identifier, a table identifier, and a record index; and
use the extracted information to locate a corresponding row in an upstream data structure that contributed to the data structure.

14. The non-transitory computer-readable storage medium of claim 11, wherein constructing the dependency graph causes the one or more processors to:
construct a trigger graph by adding the triggering function to the trigger graph and recursively adding functions that are transitively triggered by the triggering function; and
construct a data dependency graph by adding functions having data dependencies on functions in the trigger graph.

15. The non-transitory computer-readable storage medium of claim 11, wherein constructing the dependency graph causes the one or more processors to:
identify data version information for each data structure associated with functions in the dependency graph; and
use the data version information to determine which specific versions of data structures each function depends upon.

16. The non-transitory computer-readable storage medium of claim 15, wherein generating the execution plan causes the one or more processors to:
resolve relative version references to specific data structure versions based on a latest available version at an execution time; and
create placeholders for future data structure versions that will be generated during execution of the execution plan.

17. The non-transitory computer-readable storage medium of claim 11, wherein committing each transaction causes the one or more processors to:
verify that all functions within the transaction have completed successfully;
make updated data structure versions visible for consumption only after verifying successful completion of all functions within the transaction; and
maintain visibility of previous data structure versions to external consumers until the transaction commits successfully.

18. The non-transitory computer-readable storage medium of claim 11, wherein the computer program instructions, when executed by the one or more processors, further cause the one or more processors to:
detect a failure of a function within a transaction;
roll back all data structure versions created within the failed transaction; and
fail all dependent transactions that contain functions depending on data structures produced by the failed transaction.

19. The non-transitory computer-readable storage medium of claim 11, wherein executing the functions according to the execution plan causes the one or more processors to:
initiate execution of a downstream function when input data dependencies for the downstream function are satisfied by data structures produced by upstream functions within ongoing transactions;
allow the downstream function to access data structures produced by the upstream functions before the ongoing transactions commit; and
maintain visibility of updated data structure versions to external consumers subject to successful completion of the ongoing transactions.

20. A data provisioning network system comprising:
one or more processors; and
a non-transitory computer-readable storage medium comprising computer program instructions that, when executed by the one or more processors, cause the one or more processors to:
establish an initial pristine state for a plurality of data structures within the data provisioning network system, wherein the initial pristine state represents a consistent state of the plurality of data structures;
identify a trigger event associated with a triggering function;
construct a dependency graph based on the triggering function, wherein constructing the dependency graph comprises:
adding the triggering function to the dependency graph,
recursively identifying additional functions connected to the triggering function through hierarchical relationships or data dependencies, and
adding the identified additional function to the dependency graph;
generate an execution plan based on the dependency graph, wherein generating the execution plan comprises:
determining an ordered sequence of functions to execute based on the dependency graph; and
grouping the functions into one or more transactions based on a transaction strategy;
execute the functions according to the execution plan within the one or more transactions;
commit each transaction of the one or more transactions only when all functions within that transaction complete successfully; and
transition to an updated pristine state for the plurality of data structures after all transactions in the execution plan complete successfully, wherein the updated pristine state represents a new consistent state of the plurality of data structures.
